(19) United States
(12) Patent Application Publication
(10) Pub. No.: US 2010/0104969 A1
(43) Pub. Date: Apr. 29, 2010

(54) ORGANIC PHOTOCONDUCTOR, IMAGE FORMING METHOD AND IMAGE FORMING APPARATUS

(75) Inventors: Fumitaka MOCHIZUKI, Tokyo (JP); Shinichi YABUKI, Kanagawa (JP); Chigusa YAMANE, Tokyo (JP); Kunihiro OGURA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/603,258

(22) Filed: Oct. 21, 2009

(30) Foreign Application Priority Data
Oct. 24, 2008 (JP) 2008274183

(51) Int. Cl. G03G 13/16; G03G 15/00; G03G 5/047

(52) U.S. Cl. 430/125.3; 399/130; 430/58.05; 430/58.75

(57) ABSTRACT

An organic photoreceptor is disclosed, comprising on an electrically conductive support an intermediate layer, a charge generation layer, a charge transport layer and a protective layer in this order, wherein the protective layer contains inorganic particles in an amount of not less than 5% by mass and not more than 30% by mass, and a skewness (Rsk) of a cross section curve of a surface of the electrically conductive support is within a range of −8<Rsk<0.

### FIELD OF THE INVENTION

The present invention relates to an electrophotographic photoreceptor used for electrophotographic image formation, and an image forming method and an image forming apparatus using the organic photoconductor.

### BACKGROUND OF THE INVENTION

Recently, there have been increased opportunities of using electrophotographic copiers or printers in the field of printing or color printing. There is a strong trend of requiring high quality digital black-and-white or color images in such fields of printing or color printing. In response to such a requirement was proposed formation of high precision digital images by use of a short wavelength laser light, as described in, for example, Japanese Patent Application Publication JP 2000-250239A and JP 2001-105479A. However, the current condition is that even when forming a precise electrostatic latent image on an electrophotographic photoreceptor by use of a short wavelength laser light and reducing the exposure diameter, the finally obtained electrophotographic image does not achieve sufficiently high image quality.

The cause thereof is due to the fact that there were not sufficiently addressed newly generated problems in images obtained by imagewise exposure at relatively short wavelengths.

In other words, when an organic photoreceptor (hereinafter, also simply denoted as a photoreceptor), which were developed as an electrophotographic photoreceptor used for conventional long wavelength lasers, was exposed at a relatively small dot diameter by using a short wavelength laser, reversed black spots or image unevenness which was not noticed became more and more obvious, making it difficult to achieve reproduction of fine dot images.

### SUMMARY OF THE INVENTION

The present invention has been realized to solve the foregoing problems. It is an object of the present invention to provide an organic photoreceptor on which an electrostatic latent image of high density is formed upon exposure to light of a wavelength in the range of 350 to 500 nm, forming an electrophotographic image in which occurrence of reversed black spots or image unevenness is prevented and improvements are achieved in characteristics such as sensitivity, residual potential, dot reproducibility and halftone image quality; and also to provide an image forming method and an image forming apparatus by use of the foregoing organic photoreceptor.

As a result of extensive study to dissolve the foregoing problems, it was found that it was necessary to improve a phenomenon in which a conventional technique for roughening the support surface effectively inhitoold the interference fringe (moire) produced upon exposure to low wavelength laser light but which tended to cause black-spotting, whereby the present invention was achieved.

Namely, it was found that roughening the support surface was performed so as to inhibit not only interference fringe (moire) but also black-spotting and to enhance its effect, it was also effective to provide a protective layer containing inorganic particles on a photosensitive layer, whereby the present invention was achieved.

Thus, one aspect of the present invention is directed to an organic photoreceptor comprising, on an electrically conductive support, an intermediate layer, a charge generation layer, a charge transport layer and a protective layer in the sequence set forth, wherein the protective layer contains inorganic particles in an amount of not less than 5% by mass and not more than 30% by mass, and a skewness (Rsk) of a section curve of the electrically conductive support meets the requirement of −8<Rsk<0.

Another aspect of the invention is directed to an image forming method comprising the steps of (a) allowing an organic photoreceptor to be charge at a uniform electrostatic potential, (b) exposing the charged organic photoconductor to light at a wavelength in the range of 350 to 500 nm to form an electrostatic latent image, (c) developing the electrostatic latent image to form a toner image, and (d) transferring the toner image to a transfer medium, wherein the organic photoreceptor employs an organic photoreceptor described in any of 1-8.

Another aspect of the invention is directed to an image forming apparatus comprising an organic photoreceptor described in any of 1-8 and an exposure device to expose a uniform-charged organic photoconductor to light at a wavelength of 350 to 500 nm.

### BRIEF DESCRIPTION OF THE DRAWINGS

FIG. 1 illustrates an image forming apparatus relating to the invention.

FIG. 2 illustrates a sectional view of a color image forming apparatus relating to one embodiment of the invention.

FIG. 3 illustrates a sectional view of a color image forming apparatus using a photoreceptor relating to the invention.

FIG. 4 illustrates an example of a regularly recessed shape of a simple single pattern of a cross section curve.

FIG. 5 illustrates an example of a irregularly recessed shape of a complex pattern of a cross section curve.

FIGS. 6A and 6B show a conceptual scheme of the skewness (Rsk) of a cross section curve being a positive value or a negative value.

FIG. 7 illustrates an example of an apparatus for dry ice blasting.

FIG. 8 shows a perspective view of an example of an apparatus for a sand blasting.

### DETAILED DESCRIPTION OF THE INVENTION

The organic photoreceptor of the present invention is featured in that the organic photoreceptor comprises, on an electrically conductive support, an intermediate layer, a charge generation layer, a charge transport layer and a protective layer in that order, wherein the protective layer contains inorganic particles in an amount of not less than 5% by mass and not more than 30% by mass, and a skewness (Rsk) of a cross-section curve of the electrically conductive support is within the range of −8<Rsk<0.

A organic photoreceptor having the structure described above can form highly precise dot images and achieves enhanced dot reproduction and an improvement in streak-like unevenness of halftone image density, forming electrophotographic images of high quality.

Next, there will be described an electrically conductive support relating to the invention.

First, there will be described a skewness (Rsk) of a cross section curve of the surface of an electrically conductive support relating to the invention. The skewness of a cross section curve of the surface of an electrically conductive support represents the degree of skew (or degree of distortion) of the distribution of peaks (peak portions) and valleys (valley portions). When the skewness (Rsk) is not less than 0, the number of peak portions (peaks) on the conductive support surface increases and tends to result in increased frequencies of leakage discharge to the contact charging member or deteriorated dot reproducibility at a short-wavelength laser of a narrowed dot diameter. When Rsk is not more than −8, the number of peak portions (peaks) is reduced, resulting in reduced leakage discharge with a contact charging member but causing interference fringes. The skewness (Rsk) of more than −3.5 and less than −0.2 is preferred.

There are various methods for preparing the support surface exhibiting a skewness (Rsk) of a cross section curve falling within the range described above. Of these is preferred a method of subjecting the conductive support surface to a machining treatment to form a regularly recessed shape of a cross section curve of the surface, which is further subjected to a sandblasting treatment or the like to remove burrs formed by the machining treatment. In the following, there will be described a method of preparing a skewness (Rsk) of a cross section curve of a conductive support.

The regularly recessed shape of a cross section curve includes all of from a regularly recessed shape of a simple single pattern (as shown in FIG. 4) to a complex recessed pattern (as shown in FIG. 5).

Such regularly recessed pattern can be formed by a cutting work. Recessed patterns including simple to complex ones can freely be formed by variation of the shape of a tool in cutting work or by selection of a pressure angle or depth of a tool or a rotation speed.

Regularly recessed shapes of cross section curves include a completely regular-recessed pattern and incomplete regular-recessed patterns. Even if complete regularity of a cutting shape is broken by the following work such as sandblasting, incomplete regularity in which a repeating pattern of the cutting shape still remains is also included within the range of regularly recessed shapes.

Cutting tools usually employ a tool of sintered polycrystalline diamond for rough machining and that of sintered single crystalline diamond or polycrystalline diamond for finish machining. In a tool of a sintered single crystalline diamond, the nose shape may be flat or an “R” shape; in the case of an “R” shape, the radius of roundness of the nose is preferably from 10 to 30 nm. In a tool of a sintered polycrystalline diamond, the nose shape may be flat or a “R” shape, but its graininess is preferably not less than 0.2 μm and not more than 15 μm and it is also preferred to perform polishing so that the roughness after final polishing of the surface cut by a cutting tool is not less than 0.3 μm and not more than 2.0 μm in terms of maximum roughness Rt. The maximum roughness Rt of the surface cut by a cutting tool can be measured by a surface roughness tester, SURFCOM 1400D (produced by Tokyo Seimitsu Co., Ltd.). Grinding of a cutting tool is performed preferably with a diamond wheel fitted to a grinding disc tool.

The machining-feed rate (v) is set to fall within a range so that its minimum value is preferably not less than 100 μm/rev and more preferably not less than 150 μm/rev, and its maximum value is preferably not more than 600 μm/rev and more preferably not more than 450 μm/rev.

The skewness of a cross section curve, falling within the foregoing range of the invention can be achieved by subjecting a conductive support to machining, followed by being subjected to a sand blasting process, a dry ice blasting process or a high-pressure water jet treatment, in each of which the blasting intensity is optimally chosen.

### Example of Dry Ice Blasting:

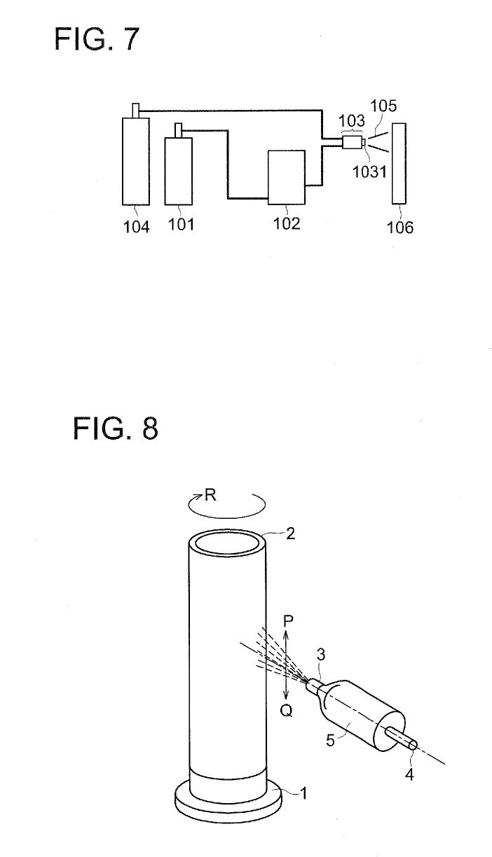

FIG. 7 illustrates an example of an apparatus for dry ice blasting used in production of an electrically conductive support relating to the invention. In FIG. 7, designation 101 is a liquefied carbon dioxide storage means (cylinder) to store liquefied carbon dioxide, designation 102 is a means for producing dry ice particles by solidifying liquid carbon dioxide through cooling or expansion, designation 103 is a jetting means (nozzle) for jetting dry ice particles, 1031 is an orifice for jetting dry ice particles, designation 104 is a high-pressure gas supplying means to supply a high-pressure gas to give a kinetic energy to dry ice particles, designation 105 is dry ice particles jetted from the orifice 1031 from the means for jetting dry ice particles (103) and designation 105 is a conductive support.

A jetting pressure “b” (in MPa) when jetting dry ice particles from the orifice of the dry ice particle-jetting means is preferably not more than 1 MPa, more preferably not more than 0.8 MPa, and still more preferably not more than 0.05 MPa. An excessively high jetting pressure often damages the conductive support (forming dents), while an excessively low jetting pressure provides insufficient kinetic energy to the dry ice particles, resulting in insufficient collision power to the conductive support. The jetting pressure “b” is a value of the tube side pressure measured by a pressure gauge at the time when dry ice particles are mixed with a high pressure gas. A distance between the dry ice jetting means and the jetting orifice, “a” (in mm) and a jetting pressure “b” (in mm) preferably meet the following expression (1), and also preferably expression (2), as described below:

a≦−300b2+620b (1)

−6b2+11b≦a (2)

Herein, for example, with reference to FIG. 7, the distance “a” (mm) is a distance from the jetting orifice to a conductive support (106) in the direction vertical to the jet surface (1032) of the jetting orifice (1031). When the distance “a” does not meet the expression (1), the kinetic energy of dry ice particles is insufficient, resulting in insufficient collision force to the first layer surface. Further, when the distance (a) does not meet the expression (2), consumption efficiency of dry ice particles tends to be lowered.

The angle between the conductive support and the dry ice particle-jetting means (namely, a nozzle) may be vertical or inclined.

Examples of a high-pressure gas to give kinetic energy to dry ice particles include nitrogen and carbon dioxide, compressed by a compressor. There may be used high-pressure air compressed by a compressor, in which it is preferred to allow air to pass through a filter to achieve enhanced cleanness of air.

The feed flow-rate of high-pressure gas is preferably not more than 500 lit/min and more preferably not more than 300 lit/min. An excessive feed flow-rate of high-pressure gas results in an increased proportion of vaporization of dry ice particles before collision to the conductive support surface, leading to lowered cleaning power. On the contrary, an insufficient feed flow-rate of high-pressure gas results in insufficient kinetic energy to the dry ice particles, leading to insufficient collision force to the support surface.

Blasting dry ice particles to the support surface is conducted preferably with rotating the support to allow dry ice particles to collide uniformly to the support surface. The rotational circumference rate of the support is preferably 10 to 200 m/min and more preferably 30 to 100 m/min. Rotation of the support achieves the effect of flicking off foreign materials released on collision, but excessively high rotation rate often flicks off dry ice particles.

Blasting dry ice particles to the support surface is conducted preferably with moving the dry ice particle blasting means and the support in the direction parallel to the rotational axis of the support to achieve uniform collision onto the support surface. The moving rate is preferably 100 to 5000 mm/min. An excessively slow rate often damages the conductive support (forming dents). Dry ice blasting may be repeated plural times.

The conductive support may be set horizontally, vertically or obliquely in the process of dry ice blasting. The number of the dry ice particle jetting means (namely, nozzle) may be single or plural. When using plural dry ice particle jetting means, the distance or angle between the dry ice particle jetting means (nozzle) and the material to be washed may be the same or different.

When a dry ice particle jetting means (nozzle) is set with being inclined to the support, the dry ice particle jetting means (nozzle) is moved preferably in the direction opposing to the jetting direction of the dry ice particles.

### Example of Sand Blasting:

FIG. 8 shows a perspective view of an example of a sand blasting apparatus. A conductive support 2 with its end is fixed to a supporting board, rotates in the direction indicated by the arrow at a prescribed rate (50 to 200 rpm), and a jet nozzle 5 which is provided with a jet orifice 3 and a compressed air feeding orifice 4 and is movable in the axis direction indicated by “PQ”, is arranged, while being kept at a prescribed distance (4-20 cm) from the outer surface.

Sand particles of 50-100 μm and compressed air are fed from a feed orifice 4 and jetted onto the outer surface of the support 2 from the jet orifice 3, while moving the injection opening at a prescribed rate of 3 to 20 mm/sec, in which the angle to the conductive support is required to be held within 10 to 80° and the jetting pressure is preferably from 1 to 5 kg/cm². An excessively large sand particle size tends to result in an excessively rough surface of the conductive support and its Rz often exceeds 3.0 μm.

Sand particles (abrasive material) used for dry sand blasting include a powdery material of alumina, carborundum, glass, synthetic resin or the like. Specifically, in cases when using an aluminum support, alumina is preferred. An excessively large particle size of an abrasive material tends to result in an excessively uneven surface and such a coarse abrasive material tends to stick into the support surface, causing convex film defects and resulting in formation of black or white spots in the image area.

### Example of High-Pressure Water Jet Treatment

Plural conductive supports are disposed with their cylindrical axes being vertical and a frame is fitted so that the supports can not fall due to a high-pressure jet liquid. A frame is preferably of such form that a support is not damaged or washing is not hindered.

The position of a high-pressure nozzle at the upper end of the support is determined by the following expression (1):

h≧Φ/[2 tan(θ/2) Expression (1)

where Φ is the diameter of a cylindrical substrate, θ is the spreading angle of a washing solution jetted from the high-pressure nozzle and h is the distance between the upper end of the cylindrical support and the jetting orifice of the nozzle. For example, when a spreading angle θ of the washing solution jetted from the high-pressure nozzle to a conductive support of a 30 mm diameter is 25°, the distance h between the upper end of the cylindrical support and the jetting orifice of the nozzle (height of a high-pressure nozzle) is 67.7 mm. The height of the high-pressure nozzle is preferably not less than 67.7 mm and close thereto.

The length of a conductive support which can achieve sufficient effects from this washing method is preferably 240 to 370 mm. The length falling within this range gives rise to no difference in washing effect in the length direction and a cylindrical substrate is washed from the upper end to the lower end without causing unevenness.

A high-pressure jetting apparatus using a high-pressure plunger pump (produced by Maruyama Excell Co., Ltd) is preferred to jet the high-pressure washing solution. A high-pressure nozzle is allowed to move horizontally at a speed of 1 to 10 mm/sec, while jetting either pure water or a 50° C. alkaline washing solution and an alkaline electrolyte exhibiting a pH of 11.5 in an amount of 3 to 15 L/min and at a spreading angle θ of 10 to 45°. The alkaline electrolyte is a washing solution obtained by electrolysis of a potassium carbonate solution.

To achieve a skewness (Rsk) of a cross section curve, falling within the cited range of the present invention, machining is referred to, for example, JP 2007-264379A; a dry ice blasting method is referred to, for example, in JP 2000-105481A and 2000-155436A; and a high-pressure jet method is referred to in JP 2006-30580A.

The skewness (Rsk) of a cross section curve (or profile), relating to the invention is defined in accordance with ISO 4287-1997 (or JIS B 0601:2001) and represented by the formula below:

$$Rsk = \frac{1}{{Rq}^{3}} ( \frac{1}{{I}_{r}} {\int }_{O}^{{I}_{r}} {Z}^{3} ( x ) d x )$$

Rq: Root mean square roughness,

Ir: Length in X-axis direction,

Z(x): Height in Z-axis direction at position x.

Further, the skewness (Rsk) of a cross section curve, relating to the present invention is determined under the conditions below.

### Measurement Conditions:

Measurement instrument: Surface roughness tester (SURFCOM 1400D, produced by Tokyo Seimitsu Co., Ltd.)

Measured length (L): 8.0 mm

Cut-off wavelength (λc): 0.08 mm

Stylus tip shape: cone of a top angle of 60°

Stylus tip angle: 0.5 μm

Measurement rate: 0.3 mm/sec

Measurement magnification: a factor of 100,000

Measurement position: three upper, intermediate and lower positions (in the case of a cylindrical support, three positions of the middle point of a line drawn parallel to the rotation axis of the cylindrical support, and intermediate points between the middle point and the end portion).

The average value of the foregoing three positions is defined as a value of the skewness (Rsk) of the invention.

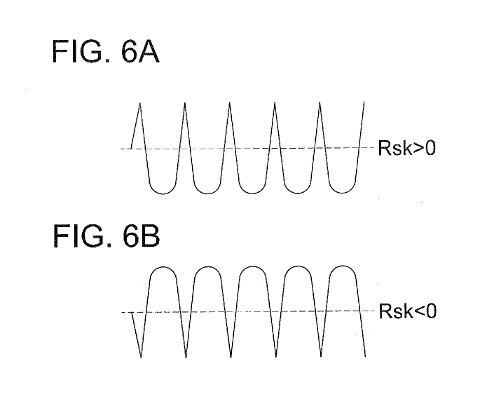

FIG. 6A and FIG. 6B illustrate a conceptual scheme of the skewness (Rsk) of a cross section curve being a positive value (Rsk>0) or a negative value (Rsk<0).

An electrically conductive support used for the photoreceptor of the invention may be in a sheet form or a cylindrical form, but the cylindrical conductive support is preferred in the invention.

The cylindrical conductive support refers to a support of a cylindrical form which enables endless image formation, and a conductive support falling within the range of a straightness of not more than 0.1 mm and a inclination of not more than 0.1 mm is preferred. A straightness and a inclination exceeding this range renders it difficult to form satisfactory images.

A cylindrical conductive support used for the photoreceptor of the invention preferably has a diameter of 10 to 300 mm, but a cylindrical conductive support of a 10-50 mm diameter is preferred to achieve marked effects of the invention and improve adhesion of the support to an intermediate layer or the like as well as black-spotting.

Materials used for an electrically conductive support include, for example, a metal cylinder such as aluminum or nickel, a plastic resin drum on which aluminum, tin oxide, indium oxide or the like is deposited and a Japanese paper or plastic drum which is coated with electrically conductive material. Specific resistivity as the electric characteristic of a conductive support is preferably not more than 10³ Ωcm at ordinary temperature (e.g., 25° C.).

There may be used a conductive support, the surface of which has been subjected to a sealing treatment to form an alumite layer. An alumite treatment is conducted usually in an acidic bath such as chromic acid or sulfuric acid, oxalic acid, phosphoric acid, boric acid, or sulfamic acid. Of these, it is specifically preferred to subject the support surface to an anodic oxidation treatment by using sulfuric acid. An anodic oxidation treatment in sulfuric acid is conducted preferably by setting conditions at a sulfuric acid concentration of 100 to 200 g/l, an aluminum ion concentration of 1 to 10 g/l, a liquid temperature of approximately 20° C. and an applied voltage of approximately 20 V but is not limited to these conditions. The average thickness of the formed anodic oxidation film is usually not more than 20 μm, preferably not more than 10 μm.

There will be specifically described the structure of a photoreceptor used in the invention.

### Conductive Support

An electrically conductive support relating to the present invention employs one exhibiting characteristics described above.

The conductive support relating to the invention is preferably prepared so that its surface roughness, expressed as a ten-point mean roughness (Rz) is from 0.5 to 2.5 μm. On the thus prepared support exhibiting such a surface roughness is constituted the foregoing skewness of a cross section curve and further thereon, an intermediate layer containing N-type semiconductor particles is provided, whereby occurrence of moire can be effectively prevented without causing dielectric breakdown or black-spotting, even when using interference light such as laser or the like.

### Definition and Measurement of Surface Roughness Rz

The foregoing Rz represents “a ten-point mean roughness” described in JIS B 0601-1982 (or ISO R 468). The ten-point mean roughness, Rz is the value of the difference, expressed in μm, between the mean value of altitudes of peaks from the highest to the 5th height and the mean value of altitudes of valleys from the deepest to the 5th height.

### Measurement Condition:

Measurement instrument: Surface roughness tester (SURFCOM 1400D, produced by Tokyo Seimitsu Co., Ltd.)

Measurement length (L): Standard value of reference length

Shape of probe needle top: cone of a top angle of 60°

Angle of probe needle top: 0.5 μm

Measurement speed: 0.3 mm/sec

Measurement magnification: 100,000 fold

Measurement position: three, upper, intermediate and lower positions (in case of a cylindrical support, three positions at the shaft center and intermediate points between the shaft center and the end portion).

The average value of Rz values at the foregoing three positions is defined as a value of a Rz of the invention.

There will be detailed the layer structure of the organic photoreceptor of the invention. Then, a protective layer relating to the invention will be described.

A protective layer relating to the invention contains inorganic particles in an amount of not less than 5% by mass and not more than 30% by mass.

The foregoing skewness of a cross section curve and a protective layer containing inorganic particles in such an amount as to inhibit density unevenness of half-tone images due to interference fringe and occurrence of black-spotting, whereby electrophotographic images of superior dot reproducibility can be obtained.

### Inorganic Particle

Examples of inorganic particles usable in the invention include particulate metal oxides (including transition metals), such as magnesium oxide, zinc oxide, lead oxide, aluminum oxide, tantalum oxide, indium oxide, bismuth oxide, yttrium oxide, cobalt oxide, copper oxide, manganese oxide, selenium oxide, iron oxide, zirconium oxide, germanium oxide, tin oxide, titanium oxide, niobium oxide, molybdenum oxide, vanadium oxide and silica. Of these, titanium oxide, aluminum oxide (alumina), zinc oxide, and tin oxide are preferred.

Inorganic particles usable in the invention are preferably those which are manufactured by conventional methods such as a gas phase process, a chlorine method, a sulfuric acid method, a plasma method and an electrolysis method.

The number average primary particle size of inorganic particles usable in the invention is preferably within the range of 1 to 300 nm, more preferably 3 to 100 nm and still more preferably 5 to 100 nm. A lower particle size is insufficient for abrasion resistance, while an excessively larger particle size often causes scattering of writing light or inhibits photocuring of particles, leading to insufficient abrasion resistance.

The number average primary particle size of inorganic particles is determined in such a manner that particles are photographed at a magnification of 10,000 fold by a scanning electron microscope (produced by Nippon Denshi Co., Ltd.) and from a photographic image having random 300 particle taken-in (excluding coagulated particles), the number average primary particle size is determined by using an automatic image processing analyzer, LUZEX AP (produced by Nireco) and software version Ver. 1.32.

The content of inorganic particles of the protective layer is preferably not less than 5% by mass and not more than 30% by mass, based on total solids.

In the invention, hydrophobicity (or methanol wettability) of inorganic particles is indicated by a measure of wettability to methanol and defined as below:

Hydrophobicity(methanol wettability)=[a/(a+50)]×100

Hydrophobicity is measured as follows. Into a 200 ml beaker having 50 ml distilled water is added 0.2 g of targeted inorganic particles. Methanol is gradually added dropwise through a buret, while the top of the buret is immersed in liquid until overall particles are wetted (or until all particles are sedimented). The amount of methanol necessary to wet all inorganic particles is defined as “a” as above, while hydrophobicity is determined by the foregoing formula.

Inorganic particles exhibiting a hydrophobicity falling within the afore-cited range can be prepared by surface-treating inorganic particle with a commonly known silane coupling agent or titanium coupling agent.

Hydrophobicity of the foregoing inorganic particles is preferably not less than 66. A hydrophobicity of not less than 66 results in enhanced advantageous effects of the invention.

The inorganic particle content (% by mass) of a protective layer is represented by % by mass, based on total solids of the protective layer. The total solids of a protective layer is the total mass of non-volatile components such as a binder resin, inorganic particles and a surface treatment agent.

In addition to the inorganic particles described above, the protective layer may contain a resin such as polycarbonate or polyarylate to disperse the inorganic particles.

The protective layer may further contain anti-oxidant or organic particles.

In the invention, an organic photoreceptor refers to an electrophotographic photoreceptor constituted of an organic compound having at least one of a charge generation function and a charge transport function which are essential to the structure of an electrophotographic photoreceptor, and includes all of known organic photoreceptors, such as a photoreceptor comprised of a commonly known organic charge generation material and/or organic charge transport material, and a photoreceptor comprised of a polymeric complex having a charge generation function and a charge transport function.

The photosensitive layer of the photoreceptor of the invention comprises, on an electrically conductive support, an intermediate layer, a charge generation layer, a charge transport layer and a protective layer.

The protective layer of a photoreceptor is one in which the photoreceptor is in contact with the aerial interface.

The charge transport layer refers to a layer having a function to transport a charge carrier generated upon exposure to light in a charge generation layer. Specific detection of such charge transport function can be achieved in such a manner that a charge generation layer and a charge transport layer are provided on a conductive support and photoconductivity is detected.

There will be further described the layer structure of an organic photoreceptor.

### Conductive Support

An electrically conductive support has been described earlier.

### Intermediate Layer

It is preferred to provide an intermediate layer between a conductive support and a photosensitive layer.

### Interlayer

The electrophotographic photoreceptor relating to the present invention may be provided with an interlayer between a conductive support and a photosensitive layer. Such an interlayer preferably contains N-type semiconductor particles. The N-type semiconductor particles refer to particles exhibiting the property of the main charge carrier being electrons. In other words, since the main charge carrier is electrons, the interlayer using N-type semiconductor particles exhibits properties of efficiently blocking hole-injection from the substrate and reduced blocking for electrons from the photosensitive layer. Preferred N-type semiconductor particles include titanium oxide (TiO₂) and zinc oxide (ZnO), of which the titanium oxide is specifically preferred.

N-type semiconductor particles employ those having a number average primary particle size of 3 to 200 nm, and preferably 5 to 100 nm. The number average primary particle size is a Feret-direction average diameter obtained in image analysis when N-type semiconductor particles are observed by a transmission electron microscope and 1,000 particles are randomly observed as primary particles from images magnified at a factor of 10000. In cases when the number average primary particle size of N-type semiconductor particles is less than 3 nm, it becomes difficult to disperse the N-type semiconductor particles in a binder constituting an interlayer and the particles are easily aggregated, so that the aggregated particles act as a charge trap, making it easy to cause a transfer memory.

When the number average primary particle size is more than 200 nm, N-type semiconductor particles cause unevenness on the interlayer surface, tendering to cause non-uniformity of images via such unevenness. Further, when the number average primary particle size is less than 200 nm, N-type semiconductor particles easily precipitate in the dispersion, often causing image non-uniformity.

Crystal forms of titanium oxide particles include a rutile type, brookite type and the like. Of these, rutile type or anatase type titanium oxide particles effectively enhance rectification of a charge passing the interlayer. Thus, mobility of electrons is enhanced to stabilize the charging potential, and increase of residual potential is inhitoold, contributing to high-density dot image formation.

N-type semiconductor particles are preferably those which were previously surface-treated with a polymer comprising a methyl hydrogen siloxane unit. A polymers comprising a methyl hydrogen siloxane unit and having a molecular weight of 1000 to 20000 effectuates enhanced surface treatment, resulting in enhanced rectifying capability of N-type semiconductor particles. Accordingly, the use of such N-type semiconductor particles prevents occurrence of black spotting and is effective in optimal halftone image formation.

The polymer comprising a methyl hydrogen siloxane unit is preferably a copolymer comprising a structural unit of —[HSi(CH₃)O]— and other structural unit (other siloxane units). Of other siloxane units, a dimethylsiloxane unit, a methylethylsiloxane unit, a methylphenylsiloxane unit or diethylsiloxane unit is preferred and a dimethylsiloxane unit is specifically preferred. The content of methyl hydrogen siloxane in a copolymer is preferably 10 to 99 mol % and more preferably 20 to 90 mol %.

A methyl hydrogen siloxane copolymer may be any one of a random copolymer, a block copolymer and a graft copolymer, but a random copolymer or a block copolymer is preferred. The copolymer may be comprised of a single component or two or more components in addition to methyl hydrogen siloxane.

Other than the foregoing N-type semiconductor particles, a coating solution to form the intermediate layer used in the invention is composed of a binder resin, a dispersing solvent and the like.

The volume of N-type semiconductor particles used in the intermediate layer is preferably 0.5 to 2.0 times that of the binder resin of the intermediate layer. Such a high density of N-type semiconductor particles in the intermediate layer results in enhanced rectification and even when the layer thickness is increased, neither an increase of residual potential nor spotting occur and black spots are effectively prevented, thereby forming an organic photoreceptor exhibiting little potential variation and capable of forming superior halftone images. The intermediate layer contains N-type semiconductor particles preferably in an amount of 100 to 200 parts by volume.

The binder resin which disperses these particles and forms an intermediate layer structure is preferably a polyamide resin. Specifically, the polyamide resin as described below is preferred.

Alcohol-soluble polyamide resin is preferred as a binder of the intermediate layer. A binder of the intermediate layer of an organic photoreceptor requires superior solubility in solvent. There are known copolymer polyamide resins composed of a chemical structure having fewer carbon atoms between amide bonds, such as 6-nylon and methoxymethylated polyamide as an alcohol-soluble polyamide, however, a polyamide resin having the following chemical structure is preferable.

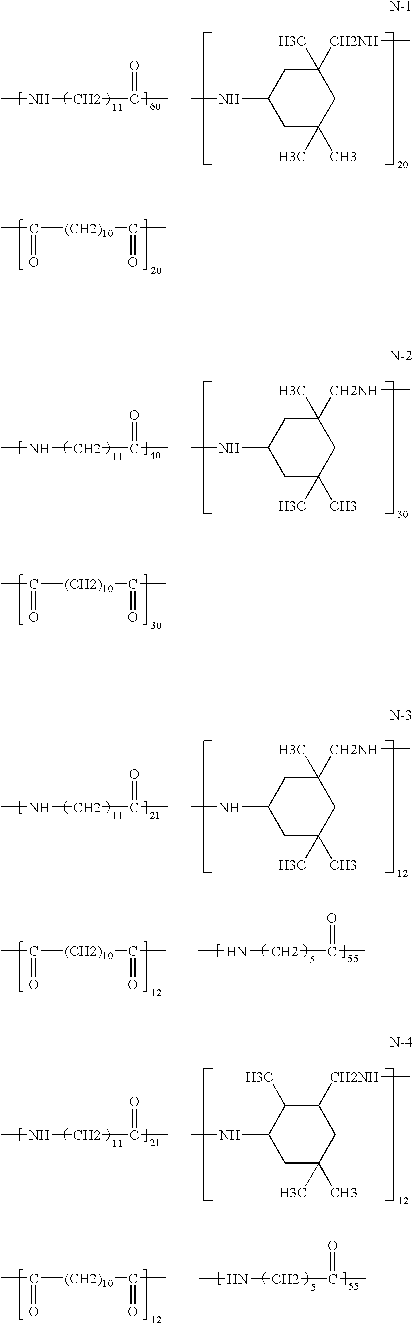

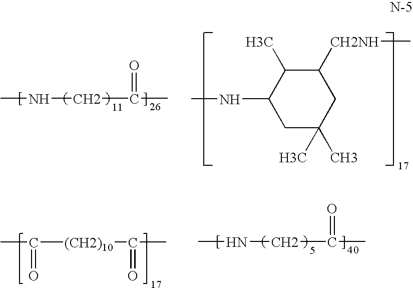

The number average molecular weight of a polyamide resin is preferably from 5,000 to 80,000, and more preferably from 10,000 to 60,000. A number average molecular weight of less than 5,000 deteriorates uniformity of the intermediate layer, resulting in insufficient advantageous effects of the invention. A number average molecular weight of more than 80,000 lowers solvent solubility of the resin, often forming aggregated resin in the intermediate layer and causing black spotting or deteriorated dot images.

The foregoing polyamide resin is commercially available, for example, Best Melt X1010 and X4685 (trade name) are available from DAICEL-DEGUSA. Co., Ltd. but can be prepared by generally known synthesis methods of polyamides.

Solvents used for dissolving the foregoing polyamide resin to prepare a coating solution are preferably alcohols having 2 to 4 carbon atoms, including, for example, ethanol, n-propyl alcohol, isopropyl alcohol, n-butanol, t-butanol and sec-butanol. These solvents preferably account for 30 to 100%, more preferably 40 to 100%, and still more preferably 50 to 100% by mass of the total solvents. Examples of an auxiliary solvent which is usable in combination with the foregoing solvents and achieves preferred effects, include methanol, benzyl alcohol, toluene, methylene chloride, cyclohexanone and tetrahydrofuran.

In the invention, the thickness of the intermediate layer is preferably from 0.3 to 10 μm, and more preferably from 0.5 to 5 μm. A thickness of less than 0.3 μm easily causes black spots, leading to deteriorated dot images. A thickness of more than 10 μm often causes an increase of residual potential, resulting in deteriorated dot images. The thickness of an intermediate layer is preferably from 0.5 to 5 μm.

The intermediate layer is preferably an insulation layer. The insulation layer refers to a layer exhibiting a volume resistance of not less than 1×10⁶ Ω·cm. In the invention, the volume resistance of an intermediate layer or a protective layer is preferably from 1×10⁸ to 1×10¹⁵ Ω·cm, more preferably from 1×10⁹ to 1×10¹⁴ Ω·cm, and still more preferably from 2×10⁹ to 1×10¹³ Ω·cm. The volume resistance can be measured, for example, as below:
Measurement condition: JIS C2318-1975
Measurement instrument: Miresta IP (produced by Mitsubishi Yuka Co.)
Measurement probe: HRS
Applied voltage: 500 V
Measurement environment: 30±2° C., 80±5% RH.

A volume resistance of less than 1×10⁸ Ω·cm results in lowered charge blocking capability of the intermediate layer, increased black spots and deteriorated potential retention of an organic photoreceptor, accordingly, superior image quality cannot be achieved. On the other hand, a volume resistance of more than 1×10¹⁵ Ω·cm often increases residual potential, while repeating image formation, so that superior image quality cannot be achieved.

### Photosensitive Layer

In the photoreceptor of the invention, the function of the photosensitive layer is separated to a charge generation layer (CGL) and a charge transfer layer (CTL). The thus separated constitution can restrain an increase of residual potential along with repeated use and can easily control other electrophotographic characters according to the object. In a negative-charged photoreceptor, it is preferred that a charge generation layer (CGL) is formed on an intermediate later and further thereon a charge transport layer (CTL) is formed.

There will be described below photosensitive layer constitution of a function-separated negative-charged photoreceptor.

### Charge Generation Layer

The photoreceptor of the invention preferably employs, as a charge generation material (CGM), a fused polycycle type pigment exhibiting a high-sensitivity characteristic in the wavelength region of 350 to 500 nm. Specifically, a pyranthrone compound represented by the afore-described formula (2) is preferred as a charge generation material. In addition to such a charge generation material of a fused polycycle type pigment, other charge generation materials may be used, and even in the case of such combined use, a fused polycycle type pigment is used in an amount of at least 50% by mass.

There are usable commonly known binders as a dispersing medium for CGM in the charge generation layer. Preferred examples of such a binder include a formal resin, butyral resin, a silicone resin, silicone-modified butyral resin and a phenoxy resin. The ratio thereof is preferably 20-600 parts by mass of charge generation material to 100 parts by mass of binder resin. The use of such a resin can minimize an increase of residual potential along with repeated use. To achieve good dot reproducibility, a charge generation layer preferably exhibits at least 0.9 of a light absorbance with respect to writing light in image exposure. Accordingly, it is necessary to control a content per unit area of a charge generation material of a charge generation layer, including layer thickness. The charge generation layer thickness is preferably from 0.2 μm to 2 μm.

In the organic photoreceptor of the present invention, the charge generation layer preferably contains, as a charge generation material, a pyranthrone compound represented by the following formula (2):

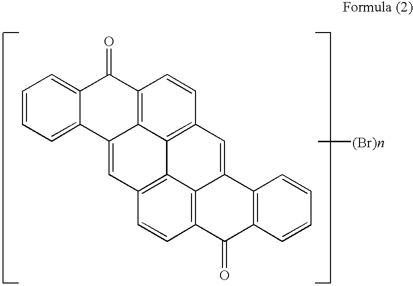

wherein n is an integer of 1 to 6.

There will be further described the compound represented by the formula (2).

In the formula (2), “n” which is the number of bromine (Br) atoms is 1 to 6 and these Br atoms can be attached to any position of R₁ to R₁₄ of the following formula (3).

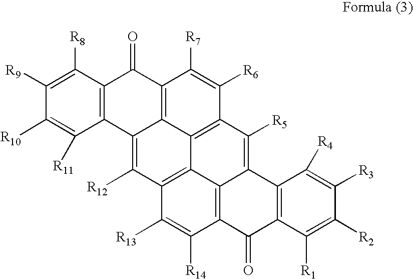

However, a means for definite identification of the Br substitution position has not been established as yet, therefore, definite identification of the substitution position is still difficult.

As shown in synthesis examples described below, the compound of the formula (2) is obtained as a mixture of compounds differing in the number of Br substituents or “n” and such a mixture is preferably used as a charge generation material of the charge generation layer of the invention.

In the following, synthesis examples of a compound of the formula (2) will be described.

### Synthesis Example 1

### CGM-1

### Mixture of n=1-3

In 50 g of chlorosulfuric acid were dissolved 5.0 g by mass of 8,16-pyranthrenedione and 0.25 g by mass of iodine, and further thereto, 3.0 g of bromine were dropwise added. After being heated with stirring at 50° C. for 3 hrs and then cooled to room temperature, the reaction mixture was poured into 500 g of ice. After being filtered, washed and dried, 6.8 g of a coarse pigment product was obtained. Into a Pyrex (trade name) glass tube was placed 5.0 g of the obtained coarse pigment product. The tube was placed in the inside of a furnace to cause a temperature gradient of approximately 440° C. to approximately 20° C. along the tube (that is, a temperature gradient of approximately 440° C. to approximately 20° C. per a length of 1 m). The inside of the glass tube was evacuated to a pressure of approximately 133.3 to 13.3 Pa and the position in which the pigment coarse product to be purified was placed, was heated to approximately 440° C. The produced vapor was transferred to the lower temperature side of the tube and condensed in the region of 300° C. to 380° C. to obtain 2.4 g by mass of a sublimed material (CGM-1).

As a result of mass spectrometry of CGM-1, it was proved that CGM-1 was a mixture of n=1-3 and the peak ratio of n=1/n=2/n=3 was 11/59/30.

### Synthesis Example 2

### CGM-2

### Mixture of n=3-5

In 50 g of chlorosulfuric acid were dissolved 5.0 g by mass of 8,16-pyranthrenedione and 0.25 g by mass of iodine, and further thereto, 5.9 g of bromine were dropwise added. After being heated with stirring at 70° C. for 5 hrs and then cooled to room temperature, the reaction mixture was poured into 500 g of ice. After being filtered, washed and dried, 8.5 g of a coarse pigment product was obtained. Into a Pyrex (trade name) glass tube was placed 5.0 g of the obtained coarse pigment product. The tube was placed in the inside of a furnace to cause a temperature gradient of approximately 460° C. to approximately 20° C. along the tube (that is, a temperature gradient of approximately 460° C. to approximately 20° C. per a length of 1 m). The inside of the glass tube was evacuated to a pressure of approximately 133.3 to 13.3 Pa and the position in which the pigment coarse product to be purified was placed, was heated to approximately 440° C. The produced vapor was transferred to the lower temperature side of the tube and condensed in the region of 300° C. to 400° C. to obtain 3.3 g by mass of a sublimed material (CGM-2).

As a result of mass spectrometry of CGM-2, it was proved that CGM-2 was a mixture of n=3-5 and the peak ratio of n=3/n=4/n=5 was 16/67/17.

### Synthesis Example 3

### CGM-3

### Mixture of n=3-6

In 50 g of chlorosulfuric acid were dissolved 5.0 g by mass of 8,16-pyranthrenedione and 0.25 g by mass of iodine, and further thereto, 5.9 g of bromine were dropwise added. After being heated with stirring at 75° C. for 6 hrs and then cooled to room temperature, the reaction mixture was poured into 500 g of ice. After being filtered, washed and dried, 8.7 g of a coarse pigment product was obtained. Into a Pyrex (trade name) glass tube was placed 5.0 g of the obtained coarse pigment product. The tube was placed in the inside of a furnace to cause a temperature gradient of approximately 480° C. to approximately 20° C. along the tube (that is, a temperature gradient of approximately 480° C. to approximately 20° C. per a length of 1 m). The inside of the glass tube was evacuated to a pressure of approximately 133.3 to 13.3 Pa and the position in which the pigment coarse product to be purified was placed, was heated to approximately 480° C. The produced vapor was transferred to the lower temperature side of the tube and condensed in the region of 300° C. to 420° C. to obtain 3.0 g by mass of a sublimed material (CGM-3).

As a result of mass spectrometry of CGM-3, it was proved that CGM-3 was a mixture of n=3-6 and the peak ratio of n=3/n=4/n=5/n−6 was 17/51/27/5.

Fused polycyclic pigments relating to the invention, except for the foregoing formula (2), include compounds shown below.

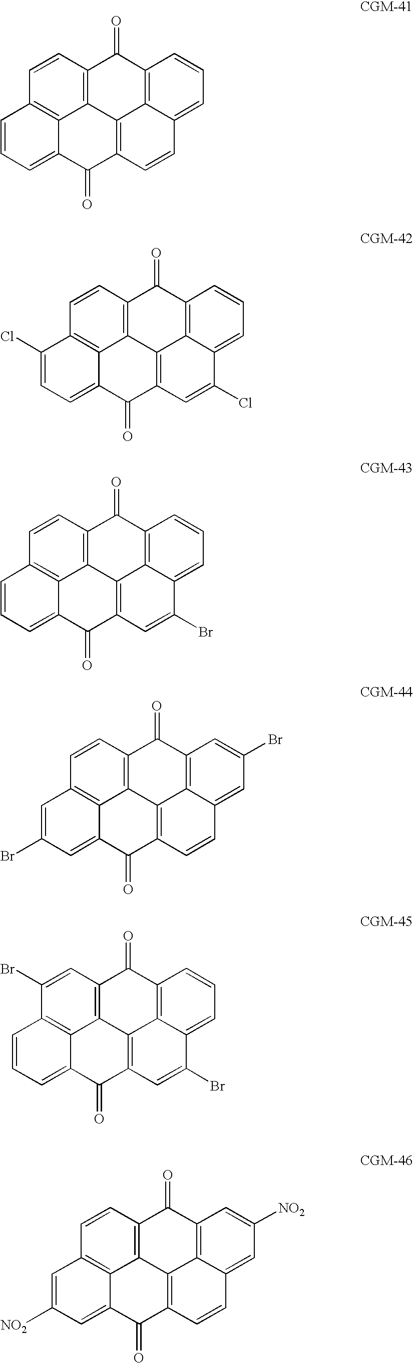

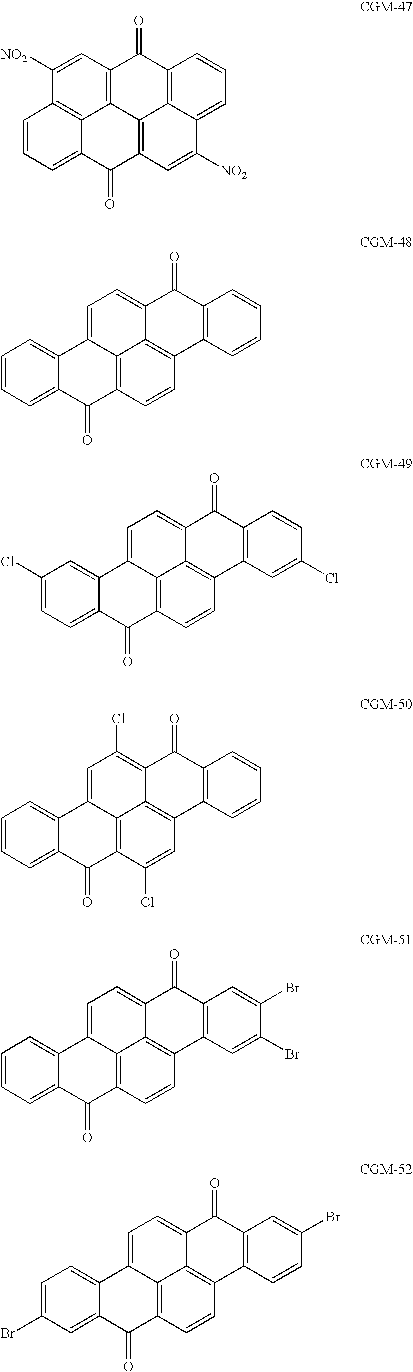

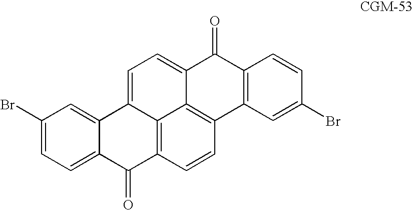

### Charge Transport Layer

In the invention, a charge transport layer may be comprised of plural layers, in which the upper most charge transport layer may contain inorganic particles of the invention.

A charge transport layer contains a charge transport material (CTM) and a binder resin to disperse CTM and to form a film. In addition, there may optionally be contained other materials, such as inorganic microparticles described earlier and an antioxidant.

The charge transport material (CTM) contains a charge transport material.

In the invention, the charge transport layer preferably contains, as a charge transport material, a triarylamine compound represented by the following formula (1):

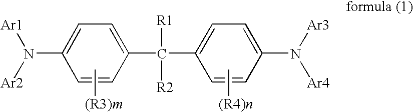

wherein R₁ and R₂ are each independently an alkyl group or an aryl group, provided that R₁ and R₂ may combine with each other to form a ring; R₃ and R₄ are each independently an alkyl group or an aryl group; Ar₁, Ar₂, Ar₃ and Ar₄ are each a substituted or unsubstituted aryl group, provided that Ar₁, and Ar₂, or Ar₃ and Ar₄ may combine with each other to form a ring; m and n are each an integer of 1 to 4.

The foregoing charge transport material exhibits no absorption in the wavelength region of 400 to 500 nm so that image-wise exposing light in the wavelength region of 400 to 500 nm reaches the charge generation layer without being cut off and also without generating a charge trap due to light exposure in the charge transport layer, thereby achieving efficient transport of a positive hole carrier from the charge generation layer to the photoreceptor surface.

A charge transport material other than the charge transport material of the formula (1) may be used, but even in such combined use, at least 50% by mass of the charge transport material of the formula (1) is used. A charge transport material is usually dissolved in a binder resin to form a layer.

Binder resins used for the charge transport layer (CTL) of the invention include, for example, polystyrene, an acryl resin, a vinyl chloride resin, a vinyl acetate resin, a polyvinyl butyral resin, an epoxy resin, a polyurethane resin, a phenol resin, a polyester resin, an alkyd resin, a polycarbonate resin, silicone resin, a melamine resin and their copolymer resin. In addition to these insulating resins is cited polymer organic semiconductors such as poly-N-vinylcarbazole. Of these resins, a polycarbonate resin is preferred in terms of lessened water-absorptivity, enhanced dispersibility of CTM and superior electrophotographic characteristics.

The ratio thereof is preferably 10 to 200 parts by mass of a charge transport material to 100 parts by mass of a binder resin.

The total thickness of a charge transport layer is preferably 10 to 35 μm. A total layer thickness of less than 10 μm is difficult to secure sufficient latent image potential in development, resulting in reduced image density and deteriorated dot reproduction. A thickness of more than 35 μm results in increased diffusion of charge carriers (diffusion of charge carriers generated in the charge generation layer), leading to deteriorated dot reproduction. In the case of being comprised of plural charge transport layers, the thickness of the uppermost charge transport layer as a surface layer is preferably from 1.0 to 8.0 μm.

Solvents and dispersing media used for an intermediate layer, a charge generation layer or a charge transport layer include, for example, n-butylamine, diethylamine, ethylenediamine, isopropanolamine, triethanolamine, triethylene diamine, N,N-dimethylformamide, acetone, methyl ethyl ketone, methyl isopropyl ketone, cyclohexanone, benzene, toluene, xylene, chloroform, dichloromethane, 1,2-dichloroethane, 1,2-dichloropropane, 1,1,2-trichloroethane, 1,1,1-trichloroethane, trichloroethylene, tetrachloroethane, tetrahydrofuran, dioxolan, dioxane, methanol, ethanol, butanol, isopropanol, ethyl acetate, butyl acetate, dimethylsulfoxide and methyl cellosolve. The invention is not limited to these, but 1,2-dichloromethane, 1,2-dichloroethane and methyl ethyl ketone are preferred. These solvents may be used singly or in combination as mixed solvents.

Usable coating methods for production of photoreceptors include, for example, immersion coating and spray coating as well as slide hopper coating.

Of coating solution-supplying type coaters, a coating method using a slide hopper type coater is most suitable for use of a coating solution of a low-boiling solvent dispersion. Coating by a circular slide hopper type coater is preferred for a cylindrical photoreceptor, as described in JP-A 58-189061.

The photoreceptor of the invention preferably contains an antioxidant in its surface layer. The surface layer is easily oxidized by an active gas such as NO or by ozone produced when electrostatically charging the photoreceptor. Co-existence of an antioxidant prevents image-blurring. Such an antioxidant is a substance which exhibits a property of preventing or inhibiting the adverse action of oxygen under conditions such as light, heat or discharge with respect to an auto-oxidative material typically existing in the interior or on the surface of the photoreceptor.

Examples of solvents or dispersants used for formation of an intermediate layer, a charge generation layer, a charge transport layer and the like include n-butylamine, diethylamine, ethylenediamine, isopropanolamine, triethanolamine, triethylene diamine, N,N-dimethylformaldehyde, acetone, methyl ethyl ketone, methyl isopropyl ketone, cyclohexane, benzene, toluene, xylene, chloroform, dichloromethane, 1,2-dichloroethane, 1,2-dichloropropane, 1,1,2-trichloroethane, 1,1,1-trichloroethane, trichloroethylene, tetrachloroethane, tetrahydrofuran, dioxolan, dioxane, methanol, ethanol, butanol, isopropanol, ethyl acetate, butyl acetate, dimethylsulfoxide, and methyl cellosolve. These solvents may be used singly or in combination.

There will be further described the charge transport material of the formula (1), relating to the invention.

Specific examples of a compound of the formula (1) are shown below.

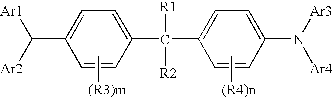

| CTM-No. | Ar1 | Ar3 | Ar2 | Ar4 |
|---|---|---|---|---|
| CTM-1 | 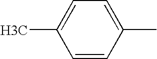 | 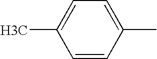 | 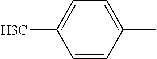 | 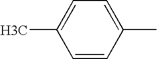 |
| CTM-2 | 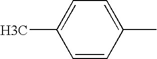 | 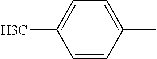 | 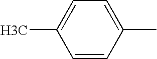 | 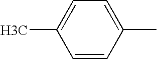 |
| CTM-3 | 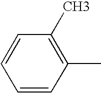 | 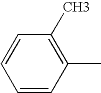 | 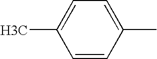 | 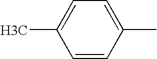 |
| CTM-4 | 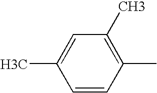 | 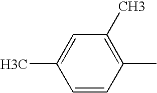 | 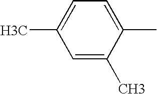 | 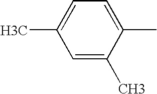 |
| CTM-5 | 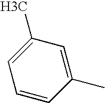 | 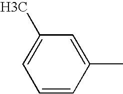 | 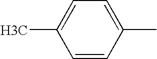 | 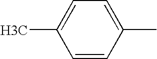 |
| CTM-6 | 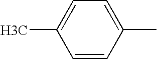 | 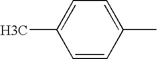 | 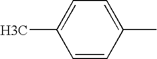 | 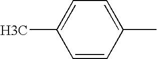 |
| CTM-7 | 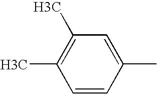 | 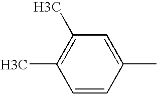 | 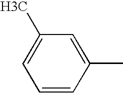 | 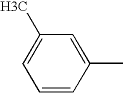 |
| CTM-8 | 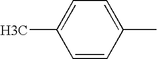 | 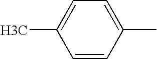 | 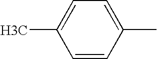 | 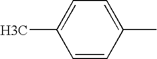 |
| CTM-9 | 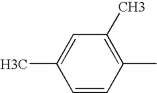 | 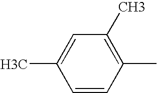 | 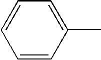 | 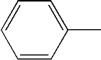 |
| CTM-10 | 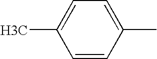 | 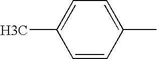 | 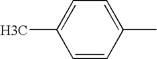 | 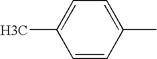 |
| CTM-11 | 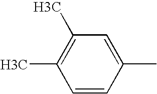 | 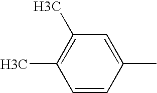 | 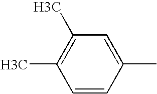 | 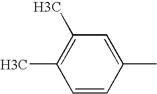 |
| CTM-12 | 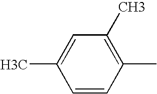 | 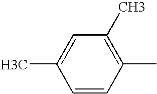 | 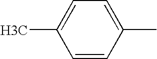 | 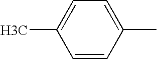 |
| CTM-13 | 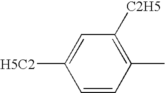 | 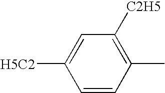 | 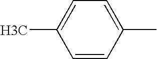 | 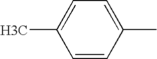 |
| CTM-14 | 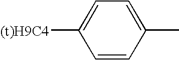 | 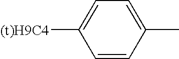 | 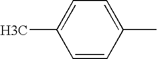 | 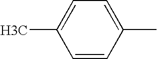 |
| CTM-15 | 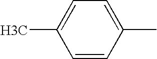 | 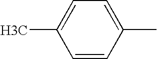 | 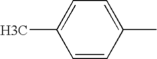 | 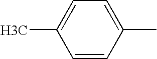 |

| CTM-No. | R1 | R2 | 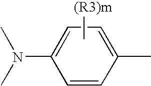 | 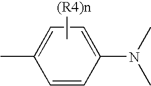 |
|---|---|---|---|---|
| CTM-1 | —CH3 | —CH3 | 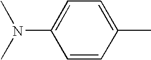 | 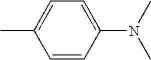 |
| CTM-2 | —CH3 | —C2H5 | 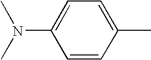 | 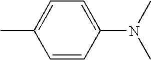 |
| CTM-3 | —CH3 | —C3H7(i)) | 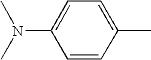 | 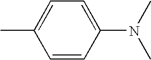 |
| CTM-4 | —CH3 | —C4H9 | 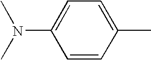 | 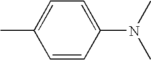 |
| CTM-5 | —CH3 | 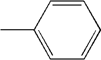 | 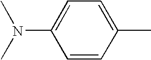 | 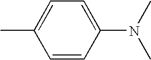 |
| CTM-6 | 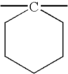 | | 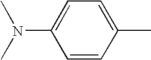 | 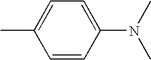 |
| CTM-7 | —CH3 | —CH3 | 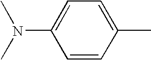 | 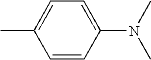 |
| CTM-8 | —H | —H | 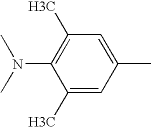 | 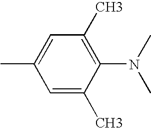 |
| CTM-9 | —CH3 | —CH3 | 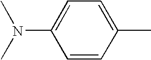 | 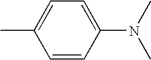 |
| CTM-10 | 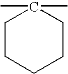 | | 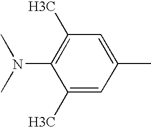 | 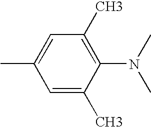 |
| CTM-11 | 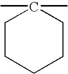 | | 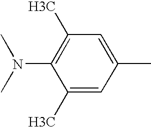 | 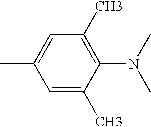 |
| CTM-12 | 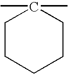 | | 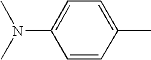 | 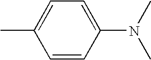 |
| CTM-13 | 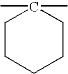 | | 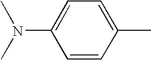 | 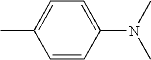 |
| CTM-14 | 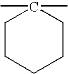 | | 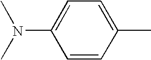 | 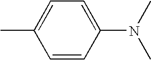 |
| CTM-15 | —C2H5 | —C2H5 | 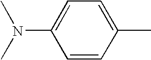 | 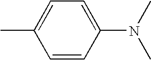 |

### Synthesis Example 1

### CTM-1

### Synthesis Example 1

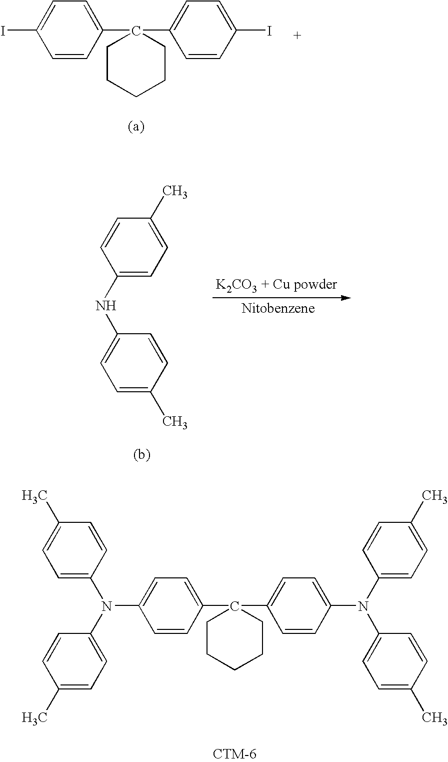

A 2000 ml four-necked flask was fitted with a condenser, a thermometer and a nitrogen-introducing tube and a magnetic stirrer was set thereto. The inside was evacuated and was completely replaced by nitrogen. To this flask, 8.1 g of (a), 12.0 g of (b), 16 g of K₂CO₃, 8.0 g of Cu powder and 40 ml of nitrobenzene were sequentially added and were reacted for 30 hrs. at 190° C., while stirring. Thereafter, the reaction mixture was treated by steam distillation and then subjected to separation and refinement in column chromatography using a developing solvent of hexane/toluene (4/1) to obtain 12 g of targeted CTM-6. The compound was identified by mass spectrometry and NMR.

A charge transport layer containing a charge transport material of the formula (1) exhibits enhanced transmittance with respect to short wave length light and can efficiently transport a charge carrier generated from the charge generation layer containing a charge generation material of the formula (2), whereby an organic photoreceptor suitable for image exposure to a short wavelength light source.

In the following, an image forming apparatus using the organic photoreceptor of the invention will be described.

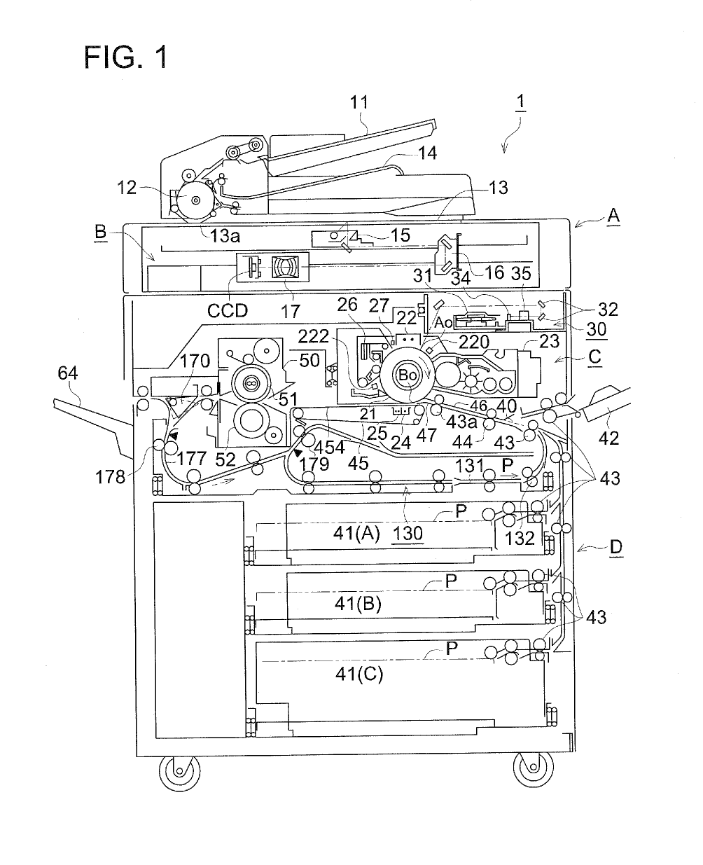

An image forming apparatus 1, as illustrated in FIG. 1, is a digital type image forming apparatus, which comprises an image reading section A, an image processing section B, an image forming section C and a transfer paper conveyance section D as a means for conveying transfer paper.

An automatic manuscript feeder to automatically convey a manuscript is provided above the image reading section. A manuscript placed on a manuscript-setting table 11 is conveyed sheet by sheet by a manuscript-conveying roller 12 and read at a reading position 13a to read images. A manuscript having finished manuscript reading is discharged onto a manuscript discharge tray 14 by the manuscript-conveying roller 12.

On the other hand, the image of a manuscript placed on a platen glass 13 is read by a reading action, at a rate of v, of a first mirror unit 15 constituted of a lighting lamp and a first mirror, followed by conveyance at a rate of v/2 toward a second mirror unit 16 constituted of a second mirror and a third mirror which are disposed in a V-form.

The thus read image is formed through a projection lens 17 onto the acceptance surface of an image sensor CCD as a line sensor. Aligned optical images formed on the image sensor CCD are sequentially photo-electrically converted to electric signals (luminance signals), then subjected A/D conversion and further subjected to treatments such as density conversion and a filtering treatment in the image processing section 13, thereafter, the image data is temporarily stored in memory.

In the image forming section C, a drum-form photoreceptor 21 as an image bearing body and in its surrounding, a charger 22 (charging step) to allow the photoreceptor 21 to be charged, a potential sensor 220 to detect the surface potential of the charged photoreceptor, developing device 23 (development step), a transfer conveyance belt device 45 as a transfer means (the transfer step), a cleaning device 26 (cleaning step) for the photoreceptor 21 and a pre-charge lamp (PCL) 27 as a photo-neutralizer (photo-neutralizing step) are disposed in the order to carry out the respective operations. A reflection density detector 222 to measure the reflection density of a patch image developed on the photoreceptor 21 is provided downstream from the developing means 23. The photoreceptor 21, which employs an organic photoreceptor relating to the invention, is rotatably driven clockwise, as indicated.

After having been uniformly charged by the charger 22, the rotating photoreceptor 21 is imagewise exposed through an exposure optical system as an imagewise exposure means 30 (imagewise exposure step), based on image signals called up from the memory of the image processing section B. The exposure optical system as an imagewise exposure means 30 of a writing means employs a laser diode, not shown in the drawing, as an emission light source and its light path is bent by a reflecting mirror 32 via a rotating polygon mirror 31, a fθ lens 34 and a cylindrical lens 35 to perform main scanning. Imagewise exposure is conducted at the position of Ao to the photoreceptor 21 and an electrostatic latent image is formed by rotation of the photoreceptor (sub-scanning). In one of the embodiments, the character portion is exposed to form an electrostatic latent image.

In the image forming apparatus of the invention, a semiconductor laser at a 350-800 nm oscillating wavelength or a light-emitting diode is preferably used as a light source for imagewise exposure. Using such a light source for imagewise exposure, an exposure dot diameter in the main scanning direction of writing can be narrowed to 10-100 μm and digital exposure can be performed onto an organic photoreceptor to realize an electrophotographic image exhibiting a high resolution of 400 to 2500 dpi (dpi: dot number per 2.54 cm). The exposure dot diameter refers to an exposure beam length (Ld, measured at the position of the maximum length) along the main-scanning direction in the region exhibiting an exposure beam intensity of not less than 1/e² of the peak intensity.

Utilized light beams include a scanning optical system using a semiconductor laser and a solid scanner of LED, while the light intensity distribution includes a Gaussian distribution and a Lorentz distribution, but the exposure dot diameter is defined as a region of not less than 1/e² of the respective peak intensities.

An electrostatic latent image on the photoreceptor 21 is reversely developed by the developing device 23 to form a visible toner image on the surface of the photoreceptor 21. In the image forming method of the invention, the developer used in the developing device preferably is a polymerization toner. The combined use of a polymerization toner which is uniform in shape and particle size distribution and the organic photoreceptor of the invention can obtain electrophotographic images exhibiting superior sharpness.

### Toner

A latent image formed on the organic photoreceptor of the invention is developed to form a toner image. A toner used for development may be a pulverization toner or a polymerization toner, but a polymerization toner prepared by a polymerization process is preferred as a toner related to the invention in terms of a stable particle size distribution being achieved.

The polymerization toner means a toner formed by a process of formation of a binder resin used for a toner and following chemical treatments. Specifically, it means a toner formed through a polymerization reaction such as suspension polymerization or emulsion polymerization, followed by coagulation and fusion of particles.

The volume average particle size of a toner, that is, 50% volume particle size (Dv50) is preferably from 2 to 9 m, and more preferably from 3 to 7 μm. This particle size range results in enhanced resolution. Further, the combination with the foregoing range can reduce the content of minute toner particles, leading to improved dot image reproducibility, superior sharpness and stable image formation.

### Developer

A developer relating to the invention may be a single component developer or two component developer.

A single component developer includes a non-magnetic single component developer and a magnetic single component developer containing 0.1-0.5 μm magnetic particles, each of which is usable.

A toner may be mixed with a carrier, which is usable as a two-component developer. In that case, there are usable commonly known materials, such as metals of iron, ferrite, magnetite or the like and alloys of these metals and a metal of aluminum or lead. Of these, ferrite particles are specifically preferred. The foregoing magnetic particles preferably are those having a volume average particle size of 15 to 100 μm (more preferably, 25 to 80 μm).

The volume average particle size of a carrier can be measured by laser refraction type particle size analyzer, HELOS (produced by SYMPATEC Co.).

A carrier is preferably one which covered with a resin or a resin dispersion type one in which magnetic particles are dispersed in a resin. A resin used for coating is not specifically limited but examples thereof include a olefin rein, styrene resin, styrene-acryl resin, silicone resin, ester resin and fluorine-containing resin. A resin constituting a resin dispersion type carrier is not specifically limited but employs commonly known one, including, for example, styrene-acryl resin, polyester resin, fluororesin, a phenol resin and the like.

In the transfer paper conveyance section D, paper supplying units 41(A), 41(B) and 41(C) as a transfer paper housing means for housing transfer paper P differing in size are provided below the image forming unit and a paper hand-feeding unit 42 is laterally provided, and transfer paper P chosen from either one of them is fed by a guide roller 43 along a conveyance route 40. After the fed paper P is temporarily stopped by paired paper feeding resist rollers 44 to make correction of tilt and bias of the transfer paper P, paper feeding is again started and the paper is guided to the conveyance route 40, a transfer pre-roller 43a, a paper feeding route 46 and entrance guide plate 47. A toner image on the photoreceptor 21 is transferred onto the transfer paper P at the position of Bo, while being conveyed with being put on a transfer conveyance belt 454 of a transfer conveyance belt device 45 by a transfer pole 24 and a separation pole 25. The transfer paper P is separated from the surface of the photoreceptor 21 and conveyed to a fixing device 50 by the transfer conveyance belt 45.

The fixing device 50 has a fixing roller 51 and a pressure roller 52 and allows the transfer paper P to pass between the fixing roller 51 and the pressure roller 52 to fix the toner by heating and pressure. The transfer paper P which has completed fixing of the toner image is discharged onto a paper discharge tray 64.

Image formation on one side of transfer paper is described above and in the case of two-sided copying, a paper discharge switching member 170 is switched over, and a transfer paper guide section 177 is opened and the transfer paper P is conveyed in the direction of the dashed arrow. Further, the transfer paper P is conveyed downward by a conveyance mechanism 178 and switched back in a transfer paper reverse section 179, and the rear end of the transfer paper P becomes the top portion and is conveyed to the inside of a paper feed unit 130 for two-sided copying.

The transfer paper P is moved along a conveyance guide 131 in the paper feeding direction, transfer paper P is again fed by a paper feed roller 132 and guided into the transfer route 40. The transfer paper P is again conveyed toward the direction of the photoreceptor 21 and a toner is transferred onto the back surface of the transfer paper P, fixed by the fixing device 50 and discharged onto the paper discharge tray 64.

In an image forming apparatus relating to the invention, constituent elements such as a photoreceptor, a developing device and a cleaning device may be integrated as a process cartridge and this unit may be freely detachable. At least one of an electrostatic charger, an image exposure device, a transfer or separation device and a cleaning device is integrated with a photoreceptor to form a process cartridge as a single detachable unit from the apparatus body and may be detachable by using a guide means such as rails in the apparatus body.

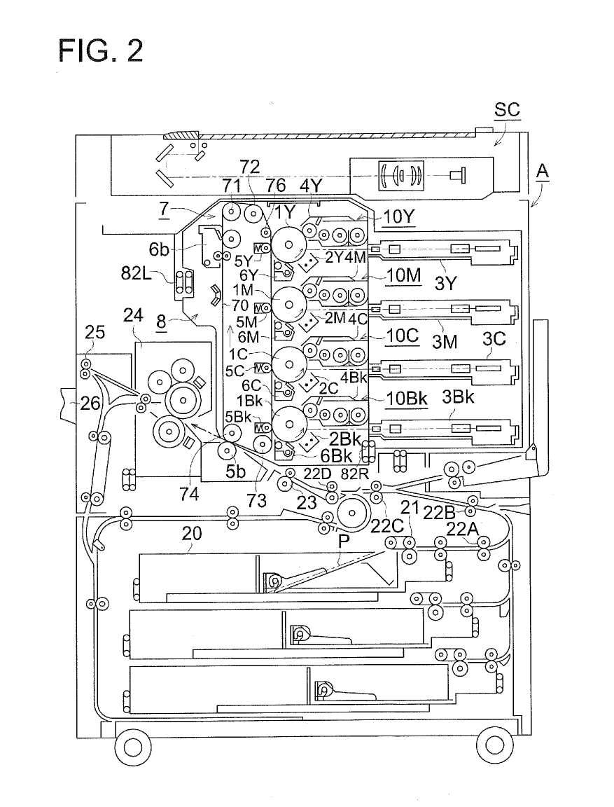

FIG. 2 illustrates a sectional view of a color image forming apparatus showing one of the embodiments of the invention.

This image forming apparatus is called a tandem color image forming apparatus, which is, as a main constitution, comprised of four image forming sections (image forming units) 10Y, 10M, 10C and 10Bk; an intermediate transfer material unit 7 of an endless belt form, a paper feeding and conveying means 21 and as a fixing means 24. Original image reading device SC is disposed in the upper section of image forming apparatus body A.

Image forming section 10Y to form a yellow image comprises a drum-form photoreceptor 1Y as the first photoreceptor; an electrostatic-charging means 2Y (electrostatic-charging step), an exposure means 3Y (exposure step), a developing means 4Y (developing step), a primary transfer roller 5Y (primary transfer step) as a primary transfer means; and a cleaning means 6Y, which are disposed around the photoreceptor 1Y.

An image forming section 10M to form a magenta image comprises a drum-form photoreceptor 1M as the second photoreceptor; an electrostatic-charging means 2M, an exposure means 3M and a developing means 4M, a primary transfer roller 5M as a primary transfer means; and a cleaning means 6M, which are disposed around the photoreceptor 1M.

An image forming section 10C to form a cyan image formed on the respective photoreceptors comprises a drum-form photoreceptor 1C as the third photoreceptor, an electrostatic-charging means 2Y, an exposure means 3C, a developing means 4C, a primary transfer roller 5C as a primary transfer means and a cleaning means 6C, all of which are disposed around the photoreceptor 1C.

An image forming section 10Bk to form a black image formed on the respective photoreceptors comprises a drum-form photoreceptor 1Bk as the fourth photoreceptor; an electrostatic-charging means 2Bk, an exposure means 3Bk, a developing means 4Bk, a primary transfer roller 5Bk as a primary transfer means and a cleaning means 6Bk, which are disposed around the photoreceptor 1Bk.

The foregoing four image forming units 10Y, 10M, 10C and 10Bk are comprised of centrally-located photoreceptor drums 1Y, 1M, 1C and 1Bk; rotating electrostatic-charging means 2Y, 2M, 2C and 2Bk; imagewise exposure means 3Y, 3M, 3C and 3Bk; rotating developing means 4Y, 4M, 4C and 4Bk; and cleaning means 5Y, 5M, 5C and 5Bk for cleaning the photoreceptor drums 1Y, 1M, 1C and 1Bk.

The image forming units 10Y, 10M, 10C and 10Bk are different in color of toner images formed in the respective photoreceptors 1Y, 1M, 1C and 1Bk but are the same in constitution, and, for example, the image forming unit 10Y will be described below.

The image forming unit 10Y disposes, around the photoreceptor 1Y, an electrostatic-charging means 2Y (hereinafter, also denoted as a charging means 2Y or a charger 2Y), an exposure means 3Y, developing means (developing step) 4Y, and a cleaning means 5Y (also denoted as a cleaning blade 5Y, and forming a yellow (Y) toner image on the photoreceptor 1Y. In this embodiment, of the image forming unit 10Y, at least the photoreceptor unit 1Y, the charging means 2Y, the developing means 4Y and the cleaning means 5Y are integrally provided.

The charging means 2Y is a means for providing a uniform electric potential onto the photoreceptor drum 1Y. In the embodiment, a corona discharge type charger 2Y is used for the photoreceptor 1Y.

The imagewise exposure means 3Y is a mean which exposes, based on (yellow) image signals, the photoreceptor drum 1Y having a uniform potential given by the charger 2Y to form an electrostatic latent image corresponding to the yellow image. As the exposure means 3Y is used one composed of an LED arranging emission elements arrayed in the axial direction of the photoreceptor drum 1Y and an imaging device (trade name: SELFOC Lens), or a laser optical system.

In the image forming apparatus relating to the invention, the above-described photoreceptor and constituting elements such as a developing device and a cleaning device may be integrally combined as a process cartridge (image forming unit), which may be freely detachable from the apparatus body. Further, at least one of a charger, an exposure device, a developing device, a transfer or separating device and a cleaning device is integrally supported together with a photoreceptor to form a process cartridge as a single image forming unit which is detachable from the apparatus body by using a guide means such as a rail of the apparatus body.

Intermediate transfer unit 7 of an endless belt form is turned by plural rollers and has intermediate transfer material 70 as the second image carrier of an endless belt form, while being pivotably supported.

The individual color images formed in image forming sections 10Y, 10M, 10C and 10Bk are successively transferred onto the moving intermediate transfer material (70) of an endless belt form by primary transfer rollers 5Y, 5M, 5C and 5Bk, respectively, to form a composite color image. Recording member P of paper or the like, as a final transfer material housed in a paper feed cassette 20, is fed by paper feed and a conveyance means 21 and conveyed to a secondary transfer roller 5b through plural intermediate rollers 22A, 225, 22C and 22D and a resist roller 23, and color images are secondarily transferred together on the recording member P. The color image-transferred recording member (P) is fixed by a heat-roll type fixing device 24, nipped by a paper discharge roller 25 and put onto a paper discharge tray outside a machine. Herein, a transfer support of a toner image formed on the photoreceptor, such as an intermediate transfer body and a transfer material collectively means a transfer medium.

After a color image is transferred onto a transfer material P by a secondary transfer roller 5b as a secondary transfer means, an intermediate transfer material 70 of an endless belt form which separated the transfer material P removes any residual toner by cleaning means 6b.

During the image forming process, the primary transfer roller 5Bk is always in contact with the photoreceptor 1Bk. Other primary transfer rollers 5Y, 5M and 5C are each in contact with the respectively corresponding photoreceptors 1Y, 1M and 1C only when forming a color image.

The secondary transfer roller 5b is in contact with the intermediate transfer material 70 of an endless belt form only when the transfer material P passes through to perform secondary transfer.

A housing 8, which can be pulled out from the apparatus body A through supporting rails 82L and 82R, is comprised of image forming sections 10Y, 10M, 10C and 10Bk and the endless belt intermediate transfer unit 7.

Image forming sections 10Y, 10M, 10C and 10Bk are aligned vertically. The endless belt intermediate transfer material unit 7 is disposed on the left side of photoreceptors 1Y, 1M, 1C and 1Bk, as indicated in FIG. 2. The intermediate transfer material unit 7 comprises the endless belt intermediate transfer material 70 which can be turned via rollers 71, 72, 73 and 74, primary transfer rollers 5Y, 5M, 5C and 5Bk and cleaning means 6b.

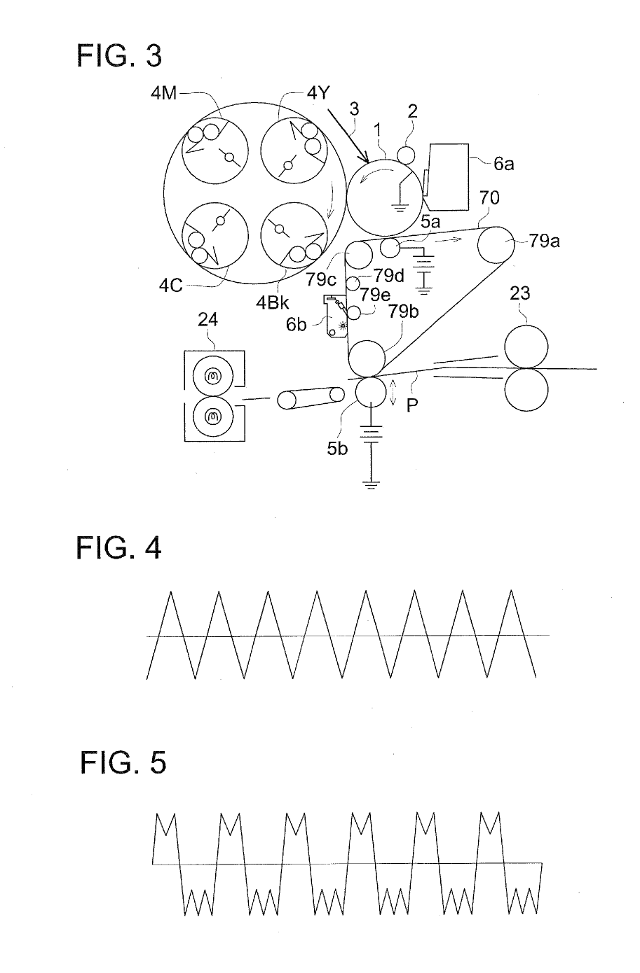

FIG. 3 illustrates a sectional view of a color image forming apparatus using an organic photoreceptor according to the invention (a copier or a laser beam printer which comprises, around the organic photoreceptor, an electrostatic-charging means, an exposure means, plural developing means, a transfer means, a cleaning means and an intermediate transfer means). The intermediate transfer material 70 of an endless belt form employs an elastomer of moderate resistance.

The numeral 1 designates a rotary drum type photoreceptor, which is repeatedly used as an image forming body, is rotatably driven anticlockwise, as indicated by the arrow, at a moderate circumferential speed.

The photoreceptor 1 is uniformly subjected to an electrostatic-charging treatment at a prescribed polarity and potential by a charging means 2 (charging step), while being rotated. Subsequently, the photoreceptor 1 is subjected to imagewise exposure via an imagewise exposure means 3 (imagewise exposure step) by using scanning exposure light of a laser beam modulated in correspondence to the time-series electric digital image signals of image data to form an electrostatic latent image corresponding to a yellow (Y) component image (color data) of the objective color image.

Subsequently, the electrostatic latent image is developed by a yellow toner of a first color in a yellow (Y) developing means 4Y: developing step (the yellow developing device). At that time, the individual developing devices of the second to fourth developing means 4M, 4C and 4Bk (magenta developing device, cyan developing device, black developing device) are in operation-off and do not act onto the photoreceptor 1 and the yellow toner image of the first color is not affected by the second to fourth developing devices.

The intermediate transfer material 70 is rotatably driven clockwise at the same circumferential speed as the photoreceptor 1, while being tightly tensioned onto rollers 79a, 79b, 79c, 79d and 79e.

The yellow toner image formed and borne on the photoreceptor 1 is successively transferred (primary-transferred) onto the outer circumferential surface of the intermediate transfer material 70 by an electric field formed by a primary transfer bias applied from a primary transfer roller 5a to the intermediate transfer material 70 in the course of being passed through the nip between the photoreceptor 1 and the intermediate transfer material 70.

The surface of the photoreceptor 1 which has completed transfer of the yellow toner image of the first color is cleaned by a cleaning device 6a.

In the following, a magenta toner image of the second color, a cyan toner image of the third color and a black toner image of the fourth color are successively transferred onto the intermediate transfer material 70 and superimposed to form superimposed color toner images corresponding to the intended color image.

A secondary transfer roller 5b, which is allowed to bear parallel to a secondary transfer opposed roller 79b, is disposed below the lower surface of the intermediate transfer material 70, while being kept in the state of being separable.

The primary transfer bias for transfer of the first to fourth successive color toner images from the photoreceptor 1 onto the intermediate transfer material 70 is at the reverse polarity of the toner and applied from a bias power source. The applied voltage is, for example, in the range of +100 V to +2 kV.

In the primary transfer step of the first through third toner images from the photoreceptor 1 to the intermediate transfer material 70, the secondary transfer roller 5b and the cleaning means 6b for the intermediate transfer material are each separable from the intermediate transfer material 70.

The superimposed color toner image which was transferred onto the intermediate transfer material 70 is transferred to a transfer material P as the second image bearing body in the following manner. Concurrently when the secondary transfer roller 5b is brought into contact with the belt of the intermediate transfer material 70, the transfer material P is fed at a prescribed timing from paired paper-feeding resist rollers 23, through a transfer paper guide, to the nip in contact with the belt of the intermediate transfer material 70 and the secondary transfer roller 5b. A secondary transfer bias is applied to the second transfer roller 5b from a bias power source. This secondary bias transfers (secondary-transfers) the superimposed color toner image from the intermediate transfer material 70 to the transfer material P as a secondary transfer material. The transfer material P having the transferred toner image is introduced to a fixing means 24 and is subjected to heat-fixing.

The image forming apparatus relating to the invention is not only suitably used for general electrophotographic apparatuses such as an electrophotographic copier, a laser printer, an LED printer and a liquid crystal shutter type printer, but is also broadly applicable to apparatuses employing electrophotographic technologies for a display, recording, shortrun printing, printing plate making, facsimiles and the like.

### Examples

The present invention will be further described with reference to examples but the embodiments of the invention are by no means limited to these. In the following examples, “part(s)” represents part(s) by mass unless otherwise noted.

### Preparation of Photoreceptor 1

### Support 1:

A flat tool of sintered diamond for complex uneven pattern cutting was used in cutting a cylindrical aluminum support and after adjusting the setting angle and a press depth, high-pressure jet cleaning was conducted at a jet pressure of 3.92 MPa by using a cleaning solution of 10-times diluted DW Be Clear CW 5524 (produced by Daiichiseiyaku Co., Ltd.) to obtain a support exhibiting a skewness (Rsk) of a cross section curve of −0.24 and a ten-point mean roughness (Rz) of 1.3 μm.

### Intermediate Layer 1:

An intermediate layer coating solution, as described below was coated on the foregoing support by a dip coating method to form an intermediate layer of a 5.0 μm dry thickness. The intermediate layer coating solution was diluted two times by the same solvent, allowed to stand overnight and filtered with a filter (lysi-mesh 5 μm filter, Nippon Pole Co., at a pressure of 50 kPa) to obtain an intermediate layer coating solution.

### Intermediate Layer Coating Solution:

| | |
|---|---|
| Binder (exemplified polyamide N-1) | 1 part |
| Anatase type titanium oxide A1 | 3 parts |
| (primary particle size of 30 nm, | |
| surface treatment with | |
| fluoroethyltrimethoxysilne) | |
| Isopropyl alcohol | 10 parts |

The foregoing composition was mixed and dispersed batch-wise for 10 hrs. by using a sand mill dispersing machine to obtain an intermediate layer coating solution.

### Charge Generation Layer:

The following composition was mixed and dispersed batch-wise by using a sand mill dispersing machine to obtain a charge generation layer coating solution. The obtained coating solution was coated onto the intermediate layer by a dip coating method to form a charge generation layer of a 0.8 μm dry layer thickness.

| | |
|---|---|
| Charge generation material (CGM-1) | 20 parts |
| Polyvinyl butyral (#6000-C, | 10 parts |
| produced by Denki Kagaku Co., Ltd.) | |
| t-Butyl acetate | 700 parts |
| 4-Methoxy-4-methyl-2-pentanone | 300 parts |

### Charge Generation Layer:

The composition, as described below was mixed and dissolved to prepare a charge transport coating solution. The coating solution was coated onto the foregoing charge generation layer by a dip coating method to form a charge transport layer of a 24 μm dry layer thickness, whereby a photoreceptor 1 was prepared.

| | |
|---|---|
| Charge transport material (CTM-6) | 75 parts |
| Polycarbonate resin (Iupilon Z300, | 100 parts |
| produced by Mitsubishi Gas Kagaku Co.) | |
| Antioxidant (AO-1) | 2 parts |
| Tetrahydrofuran/Toluene | 750 parts |
| (vol. ratio; 7/3) | |

AO-1

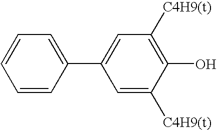

### Protective Layer:

| | |
|---|---|
| Polycarbonate resin (Iupilon Z300, | 1.5 parts |
| produced by Mitsubishi Gas Kagaku Co.) | |
| Titanium oxide* | 1.0 part |
| 1-Propanol | 5.1 parts |
| Methyl isobutyl ketone | 2.4 parts |

*Titanium oxide particles surface-treated with methylhydrogen polysiloxane (surface treatment agent:titanium oxide - 1:1), having a number average particle size of 10 nm

The foregoing mixture was dispersed by an ultrasonic homogenizer for 15 min. to prepare a protective layer coating solution.

The protective layer coating solution was coated on the photosensitive layer by a circular slide hopper method, and then dried at 90° C. for 80 min. to obtain a photoreceptor 1 having a 2 μm thick protective layer. The titanium oxide content of the protective layer of the photoreceptor 1 was 10% by mass.

### Preparation of Photoreceptor 2-10

Photoreceptors 2-10 were each prepared similarly to the foregoing photoreceptor 1, provided that values of Rsk and Rz were varied by varying the cutting conditions of the aluminum support (tool angle, press depth), the jetting pressure of dry ice or sand or by varying the titanium oxide content of the protective layer, CGM of the charge generation layer and the CTM of the charge transport layer, as shown in Table 1.

### Photoreceptor 2:

Photoreceptor 2 was prepared similarly to the photoreceptor 1, provided that in place of the high-pressure jet cleaning treatment of the support, dry ice blasting was conducted in Super-Blast DSC-1 (Fuji Seisakusho) using 3 mm dry ice particles at a jetting pressure of 0.4 MPa and the protective layer and the like were varied as shown in Table 1.

### Photoreceptor 3:

Photoreceptor 3 was prepared similarly to the photoreceptor 2, provided that 1 mm dry ice particles, the high-pressure jet cleaning treatment was conducted at a jet pressure of 0.6 MPa, and the protective layer was varied as shown in Table 2.

### Photoreceptor 4:

Photoreceptor 4 was prepared similarly to the photoreceptor 1, provided that in place of the high-pressure jet cleaning treatment of the support, precision sand blast was conducted in MICROBLASTER MB1 (produced by SHINTO BRATOR Co., Ltd.) using alumina (Al₂O₃) #5000 (average particle size: 2 μm) as a grind-sand at a blasting pressure of 0.3 MPa, and the protective layer was varied as shown in Table 2.

### Photoreceptor 5:

Photoreceptor 5 was prepared similarly to the photoreceptor 4, provided that the grind-sand was replaced by alumina (Al₂O₃) #3000 (average particle size: 5 μm) and blasting was conducted at a blasting pressure of 0.55 MPa, and the protective layer was varied as shown in Table 2.

### Photoreceptor 6:

Photoreceptor 6 was prepared similarly to the photoreceptor 1, provided that cutting work conditions were varied so that a skewness (Rsk) of cross section curve and a ten point mean roughness were as shown in Table 1, and the protective layer was varied as shown in Table 2.

### Photoreceptor 7:

Photoreceptor 7 was prepared similarly to the photoreceptor 4, provided that cutting conditions were varied so that the skewness (Rsk) of cross section curve and a ten point mean roughness were as shown in Table 1, and the protective layer was varied as shown in Table 2.

### Photoreceptor 8:

Photoreceptor 8 was prepared similarly to the photoreceptor 4, provided that the protective layer was varied as shown in Table 2.

### Photoreceptor 9 (Comparative Example)

Photoreceptor 9 was prepared similarly to the photoreceptor 2, provided that high-pressure jet cleaning was not conducted and the protective layer was varied as shown in Table 2.

### Photoreceptor 10 (Comparative Example)

Photoreceptor 10 was prepared similarly to the photoreceptor 4, provided that the blasting pressure was varied to 0.1 MPa and the protective layer was varied as shown in Table 2.

### Photoreceptor 11 (Comparative Example)

Photoreceptor 11 was prepared similarly to the photoreceptor 1, provided that polycarbonate of the protective layer was changed from 1.5 parts to 7.0 parts and the inorganic particle content of the protective layer was varied 6.3% by mass.

### Photoreceptor 12 (Comparative Example)

Photoreceptor 12 was prepared similarly to the photoreceptor 1, provided that polycarbonate of the protective layer was changed from 1.5 parts to 0.7 parts and the inorganic particle content of the protective layer was varied 29.4% by mass.

### Photoreceptor 13 (Comparative Example)

Photoreceptor 13 was prepared similarly to the photoreceptor 1, provided that polycarbonate of the protective layer was changed from 1.5 parts to 10.0 parts and the inorganic particle content of the protective layer was varied 4.5% by mass.

### Photoreceptor 14 (Comparative Example)

Photoreceptor 14 was prepared similarly to the photoreceptor 1, provided that polycarbonate of the protective layer was changed from 1.5 parts to 0.5 parts and the inorganic particle content of the protective layer was varied 33% by mass.

### Photoreceptors 15-17

Photoreceptors 15-17 were each prepared similarly to the photoreceptor 1, provided that the kind of inorganic particles of the protective layer and the layer thickness were varied as shown in Table 1.

TABLE 1

| | Conductive | | Protective Layer | | | | | | | | |
|---|---|---|---|---|---|---|---|---|---|---|---|
| Photo- | Support | | | Number Average | | | | Inorganic | Layer | Charge | Charge |
| receptor | | Rz | Inorganic | Primary Particle | Surface | | | Particle | Thickness | generation | transport |
| No. | Rsk | (μm) | Particle | Size (nm) | Treatment Agent | *¹ | *² | Content (mass %) | (μm) | layer | Layer |
| 1 | −0.24 | 1.3 | TO *³ | 6 | HS-1 | 1/1 | 71 | 20.0 | 2 | CGM-1 | CTM-6 |
| 2 | −1.36 | 1.1 | AL *⁴ | 6 | HS-2 | 1/1 | 76 | 20.0 | 2 | CGM-2 | CTM-1 |
| 3 | −3.21 | 1.0 | ZO *⁵ | 6 | HS-3 | 1/1 | 72 | 20.0 | 2 | CGM-3 | CTM-13 |
| 4 | −7.84 | 0.8 | TIO *⁶ | 6 | HS-4 | 1/1 | 67 | 20.0 | 2 | CGM-1 | CTM-15 |
| 5 | −9.78 | 0.7 | TO | 10 | HS-1 | 1/1 | 71 | 20.0 | 2 | CGM-1 | CTM-6 |
| 6 | −0.38 | 0.3 | AL | 10 | HS-2 | 1/1 | 76 | 20.0 | 2 | CGM-1 | CTM-6 |
| 7 | −0.74 | 1.8 | ZO | 10 | HS-3 | 1/1 | 72 | 20.0 | 2 | CGM-1 | CTM-6 |
| 8 | −7.84 | 0.8 | TIO | 10 | HS-4 | 1/1 | 67 | 20.0 | 2 | CGM-4 | CTM-6 |
| 9 | 1.42 | 1.3 | TO | 30 | HS-1 | 1/1 | 71 | 20.0 | 2 | CGM-1 | CTM-6 |
| 10 | 0.18 | 1.3 | AL | 30 | HS-2 | 1/1 | 76 | 20.0 | 2 | CGM-1 | CTM-6 |
| 11 | −0.24 | 1.3 | TO | 6 | HS-1 | 1/1 | 71 | 6.3 | 2 | CGM-1 | CTM-6 |
| 12 | −0.24 | 1.3 | TO | 6 | HS-1 | 1/1 | 71 | 29.4 | 2 | CGM-1 | CTM-6 |
| 13 | −0.24 | 1.3 | TO | 6 | HS-1 | 1/1 | 71 | 4.5 | 2 | CGM-1 | CTM-6 |
| 14 | −0.24 | 1.3 | TO | 6 | HS-1 | 1/1 | 71 | 33.3 | 2 | CGM-1 | CTM-6 |
| 15 | −0.24 | 1.3 | TO | 50 | HS-1 | 1/1 | 71 | 20.0 | 3 | CGM-1 | CTM-6 |
| 16 | −0.24 | 1.3 | TO | 70 | HS-1 | 1/1 | 76 | 20.0 | 4 | CGM-1 | CTM-6 |
| 17 | −0.24 | 1.3 | TIO | 30 | HS-4 | 1/1 | 68 | 20.0 | 3 | CGM-1 | CTM-6 |

*¹ Surface treatment agent (part)/Inorganic Particle (part),
*² Hydrophobicity,
*³ Titanium oxide (TO),
*⁴ Alumina (Al),
*⁵ Zinc oxide (ZO),
*⁶ Tin oxide (TIO),
In Table 1, HS-1 to HS-4 are as follows:
HS-1: Methylhydrogen polysiloxane
HS-2: Hexamethyldisilane
HS-3: Octyltrimethoxysilane
HS-4: Dimethyldichlorosilane
Further, CGM-1, CGM-2 and CGM-3 are as follows:
CGM-1: Compound of Synthesis Example 1
CGM-2: Compound of Synthesis Example 2
CGM-3: Compound of Synthesis Example 3
CGM-4: Titanyl phthalocyanine exhibiting a CuKα X-ray diffraction spectrum having peaks at Bragg angles (2θ ± 0.2°) of 27.2°.

### Evaluation

The thus obtained photoreceptors were each mounted onto a writing dot diameter-variably modified machine of a commercially available full-color hybrid machine bizhub PRO C6500 (produced by Konica Minolta Business Technologies Inc., which was set so that a 405 nm laser light was used as an image exposure light source, an exposure diameter in the main scanning direction of a writing light source was 30 nm and 1200 dpi and spot exposure of the exposure diameter was 0.5 mW on the photoreceptor surface. The foregoing full-color hybrid machine is provided with four image forming units and photoreceptors of the individual image forming units were unified to the same one (for example, in the case of photoreceptor 1, four photoreceptors were prepared), whereby evaluation was performed.

### Fogging:

Fogging was evaluated in black-and-white images. A fog density was measured in a reflection density using Macbeth RD-918. The reflection density was represented by a relative value, based on the density of non-printed A4-soze paper being 0.000. Evaluation was made based on the following criteria:

A: A density being less than 0.010 (excellent),

B: A density of not less than 0.010 and not more than 0.020 (a level of being acceptable in practice),

C: A density of more than 0.020 (a level of being unacceptable to practice).

### Reproducibility of Dot Image:

Reproduction of dot images was evaluated, based on black-and-white images.

### Evaluation of One-Dot Line:

On the white background of A4-size paper, a one-dot line and a solid black image were prepared and evaluated based on the following criteria:

A: One-dot line being continuously reproduced and a solid black image density being not less than 1.2 (excellent),

B: One-dot line being continuously reproduced but a solid black image density being less than 1.2 and not less than 1.0 (acceptable in practice),

C: One-dot line being discontinuously reproduced and a solid black image density being less than 1.0 (unacceptable in practice).

### Evaluation of Two-Dot Line:

A white line of a two-dot line was formed within a solid black image and evaluated based on the following criteria:

A: A white two-dot line being continuously reproduced and a solid black image density being not less than 1.2 (excellent),

B: A white line of a two-dot line being continuously reproduced but a solid black image density being less than 1.2 and not less than 1.0 (acceptable in practice),

C: A white line of a two-dot line being discontinuously reproduced and a solid black image density being less than 1.0 (unacceptable in practice).

In the foregoing, the image density was measured by Macbeth RD-918 and represented by a relative value, based on the reflection density of paper being 0.

### Black Spotting:

Black spotting was evaluated on a black-and-white image. The cycle was allowed to correspond to that of a photoreceptor and the number of image defects such as visible black spots and black streaks per A4 size was evaluated based on the following criteria:

A: Frequency of image defects of 0.4 mm or more being not more than 5 defects per A4 size (excellent),

B: Frequency of image defects of 0.4 mm or more being not less than 4 defects and not more than 10 defects per A4 size (acceptable in practice),

C: Frequency of image defects of 0.4 mm or more being not less than 11 defects per A4 size (unacceptable in practice).

### Evaluation of Color Image:

A halftone image including a personal portrait photograph was printed on A-4 size paper, while operating four sets of the above-described modified machine of full-color hybrid machine bizhub PRO C6500 and evaluated based on the following criteria:

A: A halftone color image being smoothly reproduced with no image unevenness nor spotting being noted,

B: An interference fringe or streak-like unevenness being caused but a halftone color image being smoothly reproduced (acceptable in practice),

C: An interference fringe, streak-like unevenness or spotting being caused overall (unacceptable in practice).

TABLE 2

| | | Dot | | | | |
|---|---|---|---|---|---|---|
| | | Reproducibility | | | | |
| Photoreceptor | | 1 dot | 2 dot | Black | Color | |
| No. | Fogging | line | line | Spotting | Image | Remark |
| 1 | A | A | A | A | A | Inv. |
| 2 | A | A | A | A | A | Inv. |
| 3 | A | A | A | A | A | Inv. |
| 4 | A | A | A | B | B | Inv. |
| 5 | B | B | B | B | C | Comp. |
| 6 | A | A | A | A | A | Inv. |
| 7 | B | A | A | A | A | Inv. |
| 8 | B | B | A | B | B | Inv. |
| 9 | B | C | B | C | B | Comp. |
| 10 | B | C | B | B | B | Comp. |
| 11 | B | A | A | A | A | Inv. |
| 12 | B | A | A | A | A | Inv. |
| 13 | B | B | B | B | C | Comp. |
| 14 | B | C | B | B | C | Comp. |
| 15 | B | A | A | A | A | Inv. |
| 16 | B | A | A | A | A | Inv. |
| 17 | B | A | A | A | A | Inv. |

As can be seen from Table 2, it was proved that photoreceptors 1-4, 6-8, 11, 12 and 15-17, in which a protective layer contained inorganic particles in an amount of not less than 5% by mass and not more than 30% by mass, and a skewness (Rsk) of a section curve of an electrically conductive support was within a range of −8<Rsk<0, achieved excellent results for the respective evaluations; on the contrary, photoreceptors 5, 9 and 10 of comparative examples in which the skewness (Rsk) of a section curve was outside the scope of the invention and photoreceptor 13 in which the content of inorganic particles of the protective layer was outside the scope of the invention, were inferior in any of evaluation items.

What is claimed is:

1. An organic photoreceptor comprising on an electrically conductive support an intermediate layer, a charge generation layer, a charge transport layer and a protective layer in this order, wherein the protective layer contains inorganic particles in an amount of not less than 5% by mass and not more than 30% by mass, and a skewness (Rsk) of a cross section curve of a surface of the electrically conductive support is within a range of −8<Rsk<0.

2. The organic photoreceptor of claim 1, wherein the skewness (Rsk) is within a range of −3.5<Rsk<−0.2.

3. The organic photoreceptor of claim 1, wherein the inorganic particles are those of at least one selected from the group consisting of alumina, titanium oxide, zinc oxide and tin oxide.

4. The organic photoreceptor of claim 1, wherein the inorganic particles exhibit a hydrophobicity of not less than 66.

5. The organic photoreceptor of claim 1, wherein the inorganic particles exhibit a number average primary particle size of 5 to 100 nm.

6. The organic photoreceptor of claim 1, wherein the charge transport layer contains a triarylamine compound represented by the following formula (1): 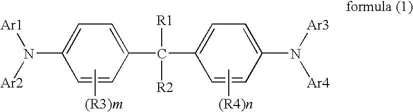
wherein R₁ and R₂ are each independently an alkyl group or an aryl group, provided that R₁ and R₂ may combine with each other to form a ring; R₃ and R₄ are each independently an alkyl group or an aryl group; Ar₁, Ar₂, Ar₃ and Ar₄ are each an aryl group, provided that Ar₁ and Ar₂ or Ar₃ and Ar₄ may combine with each other to form a ring; m and n are each an integer of 1 to 4.

7. The organic photoreceptor of claim 1, wherein the charge generation layer contains a condensed polycyclic pigment.

8. The organic photoreceptor of claim 7, wherein the condensed polycyclic pigment is a pyranthrone compound represented by the following formula (2): 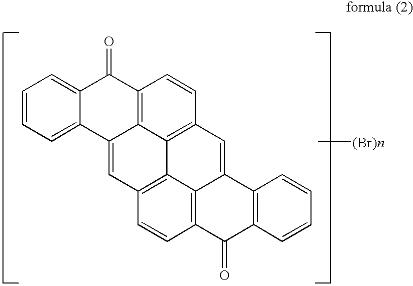
wherein n is an integer of 1 to 6.

9. The organic photoreceptor of claim 1, wherein the intermediate layer comprises a titanium oxide and a binder resin.

10. The organic photoreceptor of claim 9, wherein the binder resin is a polyamide.

11. An image forming method comprising the steps of:
(a) charging an organic photoreceptor at a uniform electrostatic potential,
(b) exposing the charged organic photoconductor to light at a wavelength in a range of 350 to 500 nm to form an electrostatic latent image,
(c) developing the electrostatic latent image to form a toner image, and
(d) transferring the toner image to a transfer medium, wherein the organic photoreceptor employs an organic photoreceptor as claimed in claim 1.

12. An image forming apparatus comprising an organic photoreceptor as claimed in claim 1 and an exposure device to expose a uniform-charged organic photoconductor to light at a wavelength of 350 to 500 nm.
